(19) United States
(12) Patent Application Publication
(10) Pub. No.: US 2013/0104667 A1
(43) Pub. Date: May 2, 2013

(54) ULTRASONIC FLOW RATE MEASURING DEVICE AND ULTRASONIC FLOW RATE MEASURING METHOD

(71) Applicant: Kabushikigaisha Izumi Giken, Saku-shi (JP)

(72) Inventor: Kiyoshi Koyano, Saku-shi (JP)

(73) Assignee: KABUSHIKIGAISHA IZUMI GIKEN, Saku-shi (JP)

(21) Appl. No.: 13/722,546

(22) Filed: Dec. 20, 2012

Related U.S. Application Data
(63) Continuation of application No. PCT/JP2011/064230, filed on Jun. 22, 2011.

(30) Foreign Application Priority Data
Jun. 22, 2010 (JP) 2010-141471
Jun. 21, 2011 (JP) 2011-137662

(51) Int. Cl. G01F 1/20

(52) U.S. Cl. CPC G01F 1/20
USPC 73/861.25

(57) ABSTRACT

An ultrasonic flow rate measuring device which measures a flow rate of a medium flowing in the tube body, when one of a plurality of the ultrasonic transmitting-receiving means transmit an ultrasonic wave as a transmitting means, by making another one of a plurality of the ultrasonic transmitting-receiving means receive the ultrasonic wave as a receiving means, and when the other ultrasonic transmitting-receiving means transmit the ultrasonic wave as the transmitting means, by making the one ultrasonic transmitting-receiving means receive the ultrasonic wave as the receiving means, wherein an ultrasonic wave propagation control means which controls a propagation of the ultrasonic wave is equipped between the ultrasonic transmitting-receiving means as the transmitting means and the receiving means. Further, the ultrasonic flow rate measuring device is easily mounted to a tube body.

### CROSS REFERENCE TO RELATED APPLICATION

This application is a continuation of International application No. PCT/JP2011/064230, filed on Jun. 22, 2011, the contents of which are incorporated herein by reference.

The present application is based on and claims priority of Japanese patent application No. 2010-141471 filed on Jun. 22, 2010, and Japanese patent application No. 2011-137662 filed on Jun. 21, 2011, the entire contents of which are hereby incorporated by reference.

### BACKGROUND OF THE INVENTION

1. Field of the Invention

The present invention relates to an ultrasonic flow rate measuring device which measures a flow rate of a fluid flowing inside a tube on the basis of a measurement result of a flow velocity of the fluid, and an ultrasonic flow rate measuring method using the ultrasonic flow rate measuring device. Specifically, the present invention relates to an ultrasonic flow rate measuring device easily fitted to a tube body, and to the ultrasonic flow rate measuring method with high precision.

The present invention relates to the ultrasonic flow rate measuring device and the method thereof which measures the flow rate of the fluid flowing inside the tube. However, the flow rate is obtained by calculation after obtaining the flow velocity of the fluid. Therefore, naturally, the present invention is applicable to a flow velocity measuring device and a flow velocity measuring method.

That is, the ultrasonic flow rate measuring device of the present invention measures the flow velocity of the fluid flowing inside the tube, and measures the flow rate thereof by multiplying a tube cross-sectional area thereto. Therefore, it is extremely easy to apply the same to a device which measures only the flow velocity, which is the first measurement result. Rather, if the technical field of the present invention is to be expressed accurately, it would be an ultrasonic flow velocity-flow rate measuring device and an ultrasonic flow velocity-flow rate measuring method.

2. Description of the Related Art

The present inventor has already disclosed, in Patent Document 1 (Japanese Patent Laid-Open No. H10-122923), an ultrasonic flow meter equipped with a detector including a tube body having a uniform diameter over the entire length thereof, with a small tube diameter for small flow rate, and which is compact. In the ultrasonic flow meter, the measurement tube has a uniform diameter over the entire length thereof, and two ring shaped ultrasonic oscillators are disposed in an axial direction of the measurement tube at a predetermined interval so as to substantially intimately contact the inner peripheral surface thereof with the outer peripheral surface of the measurement tube, wherein an ultrasonic wave is generated by applying electric AC energy to the one of the two oscillators, generated ultrasonic wave is detected by the other oscillator, the propagation time of the ultrasonic wave from the upstream side to the downstream side and the propagation time of the ultrasonic wave from the downstream side to the upstream side are measured by switching the oscillator on the transmitting side and the receiving side alternately, and the difference between the propagation time is calculated to thereby obtain the flow velocity of the fluid flowing inside the measurement tube. The measurement tube may be a straight tube or a curved non-straight tube.

As seen from the above, a technique using ultrasonic wave as a method for detecting a flow rate of a fluid medium, principally from a fluid, in a flow path constituted of comparatively soft flexible resin and the like, had already been put into practical use by the present inventor (refer to Non-Patent Document 1: http://homepage3.nifty.com/nks/IZUMIsozai/kuf10.pdf). Therefore, a basic flow rate detecting method will not be explained in the present invention.

In such flow rate detecting technique, generally, a means of inserting and adhering annular ultrasonic oscillators into the tube body is used. In the flow rate detection of a physiologic medium for medical use or a medium such as foods and drinks, it is conceivable that there may be a risk of contamination with respect to the medium during exchanging or connecting of the tube body. Therefore, easiness of cleaning inside the tube body is desired, and there are many cases where easy switching of connection of the tube body is disfavored. With such request, a system of the ultrasonic flowmeter using ultrasonic propagation of an acoustic tube type is desired as a preferable system in which the cleaning inside the tube body is easy since no detector is arranged inside the tube body.

Conventionally, a flow meter using the ultrasonic wave propagation of the acoustic tube type is, as is disclosed in Patent Document 6 (Japanese Patent Laid-Open No. H8-86675), Patent Document 7 (Japanese Utility Model Laid-Open No. S54-160167), and Patent Document 2 (Japanese Patent Laid-Open No. 2002-221440), a technique of embedding the ultrasonic oscillators inside the tube body or a technique of directly coupling the ultrasonic oscillators to the tube body using an adhesive, were used as a technique of mounting the tube body and the ultrasonic oscillators. However, in the conventional technique, when installing or exchanging the flow meter, the technique of exchanging the tube body or switching the connection thereof must be adopted. Therefore, recently, a method of measuring the flow rate by contacting a sensor portion including an ultrasonic transmitter-receiver to the tube body and transmitting and receiving the ultrasonic signal into the tube body, with a method of clamping the ultrasonic sensor portion from outer periphery of the tube body, had been realized.

Patent Document 2 discloses an ultrasonic flow meter capable of improving transmission of ultrasonic wave between the oscillator and the fluid, and accurately measuring the flow rate thereof. The ultrasonic flow meter equips measurement portions to a measurement tube body through which the fluid is made to flow, with an interval provided between the measurement portions. In the measurement portion, an arc-shaped oscillator is closely fixed to a portion of an outer peripheral surface along a circumferential direction of the measurement tube body by an adhesive, and air bubbles inside the adhesive are pushed out therefrom.

Further, Patent Document 3 (Japanese Patent Laid-Open No. 2002-303542) discloses an ultrasonic flow meter capable of suppressing influence from vibrations and temperature from outside to a minimum, and accurately measuring the flow rate. The ultrasonic flow meter provides measurement portions containing oscillator to a measurement tube body through which the fluid is made to flow, with an interval provided between the measurement portions along a longitudinal direction, and measures the flow rate by obtaining a flow velocity of the liquid from the difference in the propagation time of ultrasonic wave in both directions between the measuring portions. To a lower housing of a housing, which becomes a base portion, a pair of fixing portions is provided with a broader interval than between the measuring portions. The measurement tube body at an axially outer side of the measurement portion is held, by abutting a left-side fixing member and a right-side fixing member constituting the fixing portion, with a holding recessed portion of the two fixing members. Further, a heat insulator is filled in the housing so as to cover the measurement portion and measurement tube body.

Further, in Patent Document 4 (Japanese Patent Laid-Open No. H 10-9914), there is disclosed an invention related to an ultrasonic flow meter equipped with a detector including a tube body having a uniform diameter over the entire length thereof, with small tube diameter for small flow rate, and which is compact. In this invention, the measurement tube has a uniform diameter over the entire length thereof, three ring shaped oscillators are disposed in an axial direction of the measurement tube so as to intimately contact the inner peripheral surface thereof with the outer peripheral surface of the measurement tube, wherein ultrasonic wave is generated by means of the central oscillator of the three oscillators, the generated ultrasonic wave is detected by means of forward and rearward oscillators, and then processing the ultrasonic wave detected by the forward oscillator and that detected by the rearward oscillator by means of a comparator to obtain the flow rate of the fluid flowing through the measurement tube. The measurement tube may be a straight tube or a curved non-straight tube.

Further, with respect to a flow rate measuring method of liquid inside a tube using an acoustic tube type propagation, Patent Document 5 (Japanese Patent Laid-Open No. 2000-180228) discloses a method of adding a function of attenuating a vibration wave to a measurement tube, in order to remove the influence of the vibration wave propagating through the measurement tube itself. The first method is, in the case where the measurement tube is configured from a metal or a similar material favorably propagating the vibration wave, then to fix an acoustic filter to the measurement tube to cut or reduce the vibration wave, and a second method is to configure the measurement tube itself from a material attenuating the vibration wave.

A general technique related to flow rate measuring method of a liquid inside a tube using an acoustic tube type propagation is disclosed in Non-Patent Documents 2 (“A measurement of flow rate in a flexible tube by using sound tube propagation”, Koyano, Usui, Pan; Reports of the autumn meeting the Acoustical Society of Japan, 1997, Page 1031-1032), Non-Patent Document 3 (“A study of the acoustic wave propagation in a fluid contented tube for measuring flow rate” Koyano, Pan, Usui; Reports of the autumn meeting the Acoustical Society of Japan, September 1999, Page 1065-1036), Non-Patent Document 4 (“Experimental and numerical investigation of axisymmetric wave propagation pipe filled with fluid” H•Pan And K•Koyano Y•Usui; J•Acoust•Soc•Am. 113(6) p 3209), and Non-Patent Document 5 (“Flow rate measurement in thin tube—On acoustic tube type ultrasonic flowmeter” Izumi Giken Kabushiki Kaisha, Kiyoshi Koyano, Yoshiko Usui, Haitao Pan, Japan Industrial Publishing Co., Ltd., Ultrasonic Wave TECHNO, No. 11, Vol. 2, Page 32-36), therefore it will not be explained in the present invention.

### BRIEF SUMMARY OF THE INVENTION

The problem to be solved by the invention is to provide a flow rate measuring device of fluid inside a tube body using an ultrasonic tube propagation type, which is easy to mount to a tube body such as a tube for measuring a flow rate, and an ultrasonic flow rate measuring method using the ultrasonic flow rate measuring device. For example, Patent Document 2 discloses an ultrasonic flow meter in which an arc-shaped oscillator is closely fixed to the measurement tube body by an adhesive. However, in this case, attaching and detaching of the ultrasonic flow rate measuring device with respect to the tube body is not easy. Therefore, the present invention provides an ultrasonic flowmeter using an acoustic tube propagating type which is easy to attach and detach with respect to a tube body, by clamping the tube body by a pair of semi-annular ultrasonic sensor portions from an outer surface thereof, and provides an ultrasonic flow rate measuring means using the ultrasonic flow rate measuring device.

Further, the problem to be solved by the invention is to strongly and easily clamp the tube body by an absorption power of a magnetic, when clamping the tube body by the pair of the semi-annular ultrasonic sensor portions from the outer surface thereof, in the ultrasonic flow meter.

As a means for solving the problem mentioned above, a pair of ultrasonic transmitting-receiving means is accommodated in a case which is freely opened and closed. However, because of including such case in the configuration, the received ultrasonic wave includes unnecessary propagating wave transmitted through the case, at a reaching time position of a proper propagating wave intended for flow velocity measurement which propagates through a medium inside a tube body, thus disturbing the measurement of the proper propagating wave. Therefore, a further problem to be solved by the invention is to control propagation of the ultrasonic wave inside the case, so that the unnecessary propagating wave transmitting in the case does not disturb the measurement of the proper propagating wave propagating through the medium inside the tube body. And one of the specific method of the ultrasonic wave propagation control is to delete or attenuate the unnecessary propagating wave transmitting inside the case.

Further, the problem to be solved by the present invention is to apply the technique disclosed in Patent Document 5 in order to achieve the ultrasonic wave propagation control, and to configure the magnet which clamps the pair of the semi-annular ultrasonic sensor portions to the tube body by the adsorption force as an acoustic filter, so as to make the same contribute to deletion of attenuation of the unnecessary propagating wave transmitting inside the case.

Further, the problem to be solved by the invention is, as another specific method of controlling the propagation of the ultrasonic wave inside the case, to vary an ultrasonic wave propagating speed of a contact portion between the ultrasonic transmitting-receiving means and the tube body, and the ultrasonic wave propagating speed of the contact portion between the ultrasonic transmitting-receiving means and the case, so that the unnecessary propagating wave transmitting inside the case does not disturb the measurement of the proper propagating wave propagating through the medium inside the tube body. That is, the contact portion between the ultrasonic transmitting-receiving means and the tube body is configured from an acoustic coupling material such as a solid rubber having large ultrasonic wave propagating speed, and the contact portion between the ultrasonic transmitting-receiving means and the case is configured from an ultrasonic wave propagation decelerating material, such as a closed-pore foaming material or Japanese paper having small ultrasonic wave propagating speed. By doing so, the propagating speed of the unnecessary propagating wave transmitting in the case is slowed.

Further, the problem to be solved by the invention is, as another method for slowing the propagating speed of the unnecessary propagating wave transmitting in the case, to form a detour route of the propagating wave in an ultrasonic wave propagating path in the case, so as to delay the receiving time of the unnecessary propagating wave, so that the propagating wave transmitted in the case does not disturb the measurement.

An ultrasonic flow rate measuring device of the present invention is an ultrasonic flow rate measuring device, including: a pair of upper and lower sensor cases configured to open and close freely, which clamps a tube body inside which a fluid to be measured flows from above and below; and at least one sensor case is embedded with a plurality of two or more semi-annular ultrasonic transmitting-receiving means, with a predetermined distance therebetween; and which measures a flow rate of a medium flowing in the tube body by one of a plurality of the ultrasonic transmitting-receiving means transmitting an ultrasonic wave as a transmitting means, and another one of a plurality of the ultrasonic transmitting-receiving means receiving the ultrasonic wave as a receiving means, characterized in that an ultrasonic wave propagation control means which controls a propagation of the ultrasonic wave is equipped between the ultrasonic transmitting-receiving means as the transmitting means and the receiving means.

Further, the ultrasonic flow rate measuring device of the present invention is characterized in that a plurality of the ultrasonic transmitting-receiving means is configured from a pair of the ultrasonic transmitting-receiving means, and is configured so that in case one of the ultrasonic transmitting-receiving means transmits the ultrasonic wave as the transmitting means, the other ultrasonic transmitting-receiving means receives the ultrasonic wave as the receiving means, and in case the other ultrasonic transmitting-receiving means transmits the ultrasonic wave, the one ultrasonic transmitting-receiving means receives the ultrasonic wave as the receiving means.

Further, the ultrasonic flow rate measuring device of the present invention is characterized in that it is configured from three ultrasonic transmitting-receiving means, and is configured so that the ultrasonic transmitting-receiving means positioned at a center transmits the ultrasonic wave as the transmitting means, and the ultrasonic transmitting-receiving means positioned at both sides receive the ultrasonic wave as the receiving means.

Further, the ultrasonic flow rate measuring device of the present invention is characterized in that the ultrasonic wave propagation control means is a groove portion formed in a state of shielding an ultrasonic wave propagating path in the sensor case vertically to a tube axial direction of the tube body.

Further, the ultrasonic flow rate measuring device of the present invention is characterized in that the ultrasonic wave propagation control means is configured from a plurality of ultrasonic wave attenuating means, and a first ultrasonic wave attenuating means is a first groove portion formed in a state of shielding an ultrasonic wave propagating path in the sensor case vertically to a tube axial direction of the tube body, and a second ultrasonic wave attenuating means is a second groove portion formed so as to surround the ultrasonic transmitting-receiving means.

Further, the ultrasonic flow rate measuring device of the present invention is characterized in that the ultrasonic wave attenuating means including the groove portion is mounted with a foam body or a Japanese paper in the groove portion.

Further, the ultrasonic flow rate measuring device of the present invention is characterized in that the pair of the upper and lower sensor cases is freely opened and closed mutually and axially by a hinge.

Further, the ultrasonic flow rate measuring device of the present invention is characterized in that the ultrasonic wave propagation control means is configured from a flange having an acoustic filter effect of absorbing the ultrasonic wave propagating through the pair of the upper and lower sensor cases.

Further, the ultrasonic flow rate measuring device of the present invention is characterized in that the flange having the acoustic filter effect configuring the ultrasonic wave propagation control means is configured from a magnet material.

An ultrasonic flow rate measuring method of the present invention is a method of measuring a flow rate of a medium flowing inside a tube body, which uses an ultrasonic flow rate measuring device, having a pair of upper and lower sensor cases configured to open and close freely, which clamps a tube body inside which a fluid to be measured flows from above and below; and at least one sensor case is embedded with a plurality of two or more semi-annular ultrasonic transmitting-receiving means, with a predetermined distance therebetween; and which measures a flow rate of a medium flowing in the tube body by one of a plurality of the ultrasonic transmitting-receiving means transmitting an ultrasonic wave as a transmitting means, and another one of a plurality of the ultrasonic transmitting-receiving means receiving the ultrasonic wave as a receiving means, the ultrasonic flow rate measuring device further including an ultrasonic wave propagation control means which controls a propagation of the ultrasonic wave between the ultrasonic transmitting-receiving means as the transmitting means and the receiving means, characterized in that the flow rate of the medium flowing inside the tube body is measured by, first stopping a transfer of the medium during bottling or canning of the medium to set a flow velocity of the medium to zero and perform zero-point measurement by activating the ultrasonic flow rate measuring device, and thereafter starting the transfer of the medium and activate the ultrasonic flow rate measuring device so as to measure the flow velocity of the medium flowing inside the tube body.

### BRIEF DESCRIPTION OF THE DRAWINGS

FIG. 1 is a perspective view of a sensor case in an opened state, when mounting an ultrasonic flow meter of Embodiment 1 of the present invention to a tube body;

FIG. 2 is a perspective view of the sensor case in the opened state, when mounting the ultrasonic flow meter of Embodiment 2 of the present invention to the tube body;

FIG. 3A is a view showing a frame format of an attenuating state and a detouring state of an ultrasonic wave propagating wave propagating through a lower sensor case in Embodiment 1 of the present invention;

FIG. 3B is a view showing a frame format of the attenuating state and the detouring state of the ultrasonic wave propagating wave propagating through the lower sensor case in Embodiment 2 of the present invention;

FIG. 4 is a configuration diagram of detailed arrangement of a first and a second ultrasonic attenuating means in Embodiment 2 of the present invention;

FIG. 5A is a cross-sectional view showing A-A cross-section of FIG. 4;

FIG. 5B is a cross-sectional view showing B-B cross-section of FIG. 4;

FIG. 5C is a cross-sectional view showing C-C cross-section of FIG. 4;

FIG. 5D is a cross-sectional view showing D-D cross-section of FIG. 4;

FIG. 5E is a cross-sectional view showing E-E cross-section of FIG. 4;

FIG. 5F is a cross-sectional view showing F-F cross-section of FIG. 4;

FIG. 5G is a cross-sectional view showing G-G cross-section of FIG. 4;

FIG. 6 is a perspective view of the sensor case in the opened state, when mounting the ultrasonic flow meter of Embodiment 3 of the present invention to the tube body;

FIG. 7A is a view showing a frame format of the attenuating state and the detouring state of the ultrasonic wave propagating wave propagating through the lower sensor case in Embodiment 3 of the present invention;

FIG. 7B is a view showing a frame format of the attenuating state and the detouring state of the ultrasonic wave propagating wave propagating through the lower sensor case in Embodiment 4 of the present invention;

FIG. 8 is a configuration diagram of detailed arrangement of a first, second and third ultrasonic wave attenuating means in Embodiment 4 of the present invention;

FIG. 9A is a waveform diagram measuring a propagation time relationship between a transmitting wave and receiving signal in the case where no ultrasonic wave attenuating means is provided to the sensor case;

FIG. 9B is a waveform diagram of a wave propagating through the sensor case only, in the case where the ultrasonic wave attenuating means is formed in the sensor case, and in the case where no fluid medium exists inside the tube;

FIG. 9C is a waveform diagram of a received signal propagated through the fluid medium, in the case where the ultrasonic wave attenuating means is formed in the sensor case, the fluid medium is filled in the tube, and a transmitting signal is transmitted therein;

FIG. 10 is a perspective view of the sensor case in the opened state, when mounting the ultrasonic flow meter in Embodiment 5 of the present invention to the tube body;

FIG. 11A is an overall perspective view of an ultrasonic transmitting-receiving element in Embodiment 5 of the present invention;

FIG. 11B is a cross-sectional view showing B-B cross-section in FIG. 11A;

FIG. 11C is a cross-sectional view showing C-C cross-section in FIG. 11A;

FIG. 11D is a cross-sectional view showing B-B cross-section in FIG. 11A of a different configuration;

FIG. 12 is an overall perspective view of the ultrasonic transmitting-receiving element in Embodiment 6 of the present invention; and

FIG. 13 is an overall perspective view of the ultrasonic transmitting-receiving element in Embodiment 7 of the present invention.

### DETAILED DESCRIPTION OF THE PREFERRED EMBODIMENTS

Hereinafter, each embodiment of the present invention will be explained with reference to the drawings.

### Embodiment 1

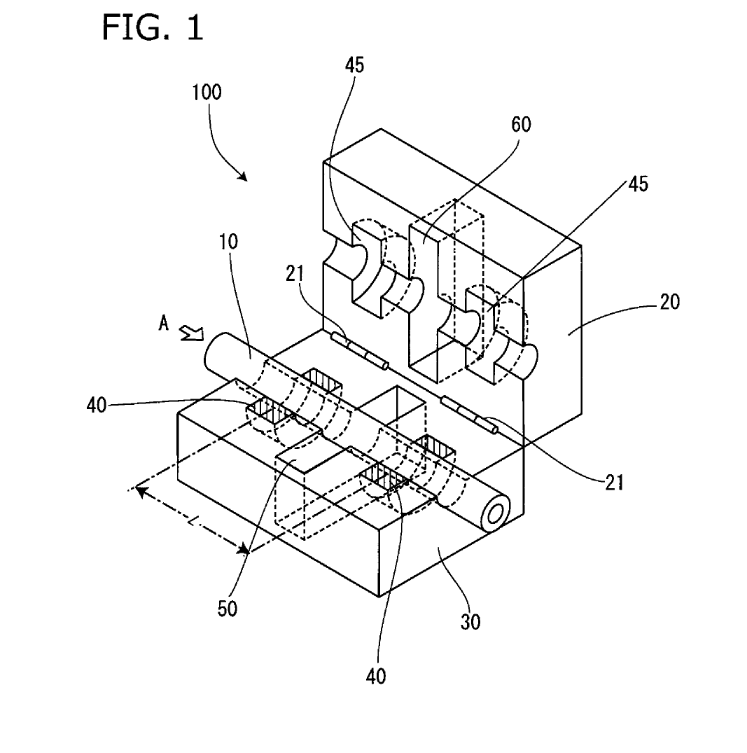

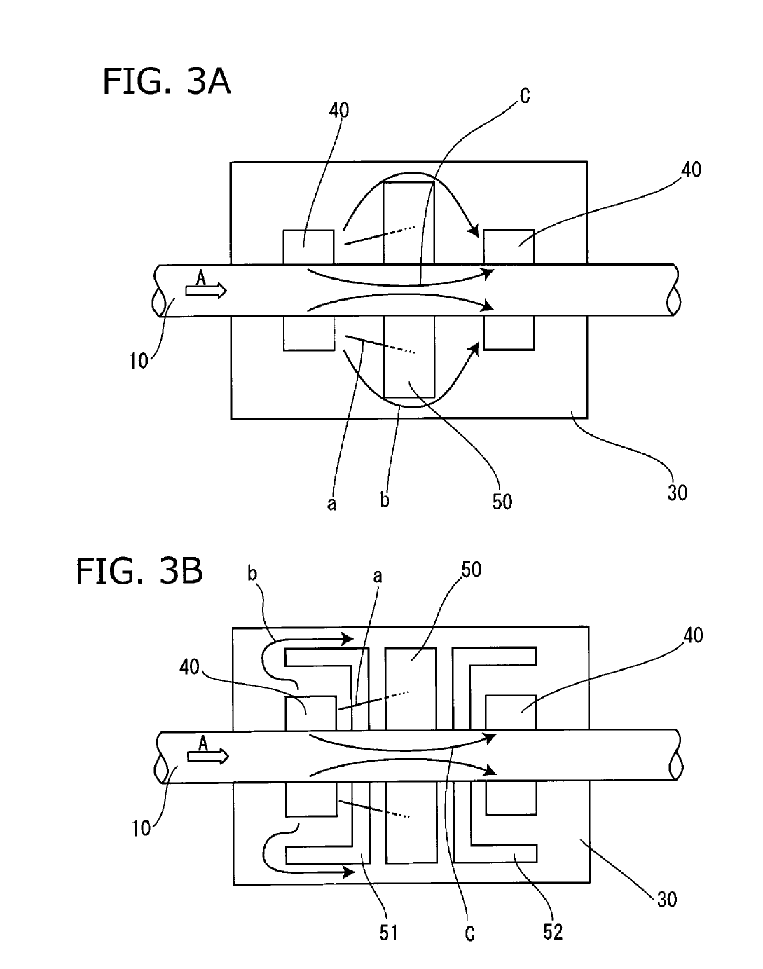

An Embodiment 1 of the present invention is an embodiment of a configuration equipped with a pair of ultrasonic transmitting-receiving means 40, and is shown in FIG. 1 and FIG. 3A. FIG. 1 is a perspective view in the case where an ultrasonic flow meter 100 of Embodiment 1 is mounted to a tube 10, and a perspective view in the state where a pair of upper and lower sensor cases 20, 30 of the ultrasonic flow meter 100 is opened. In the present specification, vertical, anteroposterior, and lateral directions are represented in the direction shown in FIG. 1. Therefore, it is a matter of design variation to arrange the same upside down, left-right reversed, and front-back reversed, when applied to a product, and is obviously included in the technical range of the present invention. Further, in the following embodiments, a cross-sectional shape of a transfer tube may be any shape such as circular, oblong, horn-shape, but will be explained in the embodiments as a tube.

The ultrasonic flow meter 100 of Embodiment 1 is configured from a pair of the upper and lower sensor cases 20, 30. The upper and lower sensor cases 20, 30 are configured so as to be freely opened and closed by a hinge 21. When the upper and lower sensor cases 20, 30 are closed, the upper and lower sensor cases 20, 30 clamps the tube 10 in which a fluid (medium) to be measured flows from above and below. The opening-closing means of the upper and lower sensor cases 20, 30 may be arbitrarily selected and altered, other than the other means specifically explained in the embodiments later. To at least one of the sensor case of the upper and lower sensor cases 20, 30 (in the embodiment shown in FIG. 1, to the lower sensor case 30) a pair of semi-annular ultrasonic transmitting-receiving means 40 is embedded with a predetermined distance L therebetween. The pair of the ultrasonic transmitting-receiving means 40 is equipped with a transmitting and receiving function of ultrasonic wave, and in the case where one transmits ultrasonic wave as the transmitting means, the other functions as the receiving means, and in the case where the other transmits ultrasonic wave as the transmitting means, one functions as the receiving means. In order to realize such function, it is easily achieved by providing a switch which switches a direction of power supply to the pair of the ultrasonic transmitting-receiving means 40. Further, it is preferable that internal diameter surface of the pair of the semi-annular ultrasonic transmitting-receiving means 40 closely contacts an outer peripheral surface of the tube 10.

An operating principle of the present invention will be explained. By closing the upper and lower sensor cases 20, 30 shown in FIG. 1, contacting the pair of the ultrasonic transmitting-receiving means 40 to the outer periphery of the tube 10, and transmitting the ultrasonic wave from one of the ultrasonic transmitting-receiving means 40 (for example, the left element in FIG. 1), an ultrasonic pressure field is formed in the medium flowing inside the tube 10. An acoustic pressure of the ultrasonic pressure field is propagated as an ultrasonic signal in an axial direction of the tube 10, via the medium inside the tube 10, and a delivery signal is acoustic-electric converted and received by the other ultrasonic transmitting-receiving means 40 (for example, right side element in FIG. 1). Subsequently, measurement is performed by switching the direction of transmitting and receiving. In such switching sensor type, the ultrasonic wave propagating in a same direction as a direction A of the flow of the medium is velocity modulated by a flow velocity of the medium, and reaches faster by the flow from a state in which the flow of medium is stopped. On the other hand, the ultrasonic wave propagating in a direction against the direction A of the flow of medium is velocity modulated by the flow velocity of the medium, and reaches slower by the flow from a state in which the flow of medium is stopped. The flow rate of the medium flowing inside the tube 10 is obtained using this principle and measuring a reaching time difference and detecting the flow velocity of the medium. This principle itself is from a technique already known.

At this time, the ultrasonic transmitting-receiving means 40 is arranged at a part of the outer periphery (for example, semi-annularly) along the outer periphery of the tube 10. However, since the present invention is not an invention on the ultrasonic transmitting-receiving means itself, no detailed explanation will be given on the structure of the ultrasonic transmitting-receiving means 40 itself. The pair of the sensor cases 20, 30, to which the ultrasonic transmitting-receiving means 40 is embedded, is prepared by molding with a plastic material having a similar hardness with or a slightly harder elastic modulus than a material of the tube 10. The pair of the sensor cases 20, 30 is made to press the outer periphery of the tube 10 at the molded portion, so as to achieve the contact state, so that when the ultrasonic transmitting-receiving means 40 is driven, a pressure wave, that is, an ultrasonic acoustic field is formed at the medium inside the tube 10. At this time, it is necessary to closely contact the inner peripheral surface of the ultrasonic transmitting-receiving means 40 and the outer periphery surface of the tube 10 so that no gap is formed therebetween. On the other hand, the ultrasonic transmitting-receiving means 40 with a similar structure is arranged on the other end side, and when the ultrasonic wave generated by the earlier-driven ultrasonic transmitting-receiving means 40 (for example, the element on the left side in FIG. 1) propagates through the medium inside the tube 10 and reaches the position of the ultrasonic transmitting-receiving means 40 on the other end side (for example, the element on the right side in FIG. 1), the ultrasonic transmitting-receiving means 40 (the element on the right side in FIG. 1) receives the pressure wave, and the signal may be delivered by receiving-electric converting the signal.

By arranging the set of the ultrasonic transmitting-receiving means 40 (the ultrasonic transmitting-receiving elements) having such function in the pair of the sensor cases shown in FIG. 1 with an interval of the predetermined distance L therebetween, and by transmitting and receiving the ultrasonic wave between the pair of the ultrasonic transmitting-receiving means 40, it becomes possible to detect the flow velocity of the medium flowing inside the tube 10. And when the flow velocity of the medium is detected, the flow rate of the medium flowing inside the tube 10 may be detected, by multiplying a previously known inner-diameter cross-sectional area of the tube 10. This method had already been explained.

In Embodiment 1 shown in FIG. 1, the pair of the ultrasonic transmitting-receiving means 40 is embedded to only one of the sensor case (in Embodiment 1 in FIG. 1, to the lower sensor case 30), and in the other sensor case (in Embodiment 1 in FIG. 1, to the upper sensor case 20), a pair of annular void portions 45 is formed at positions corresponding to the pair of the ultrasonic transmitting-receiving means 40. By doing so, the pair of the ultrasonic transmitting-receiving means 40 is fixed with respect to the tube 10 so that the tube 10 and the pair of the ultrasonic transmitting-receiving means 40 closely contact each other, by closing the pair of the sensor cases 20, 30. The function of the annular void portion 45 is to have an effect of preventing the ultrasonic wave transmitted from the ultrasonic transmitting-receiving means 40 from propagating to the upper sensor case 20. However, the fixing means is not specifically limited to a hinge, and may be achieved by means such as a detachable hook, or a bolting means piercing through the upper and lower sensor cases 20, 30. In any case, it is important to maintain the close contact to the extent that the propagation of the ultrasonic wave between the tube 10 and the pair of the ultrasonic transmitting-receiving means 40 is possible. Although not shown, the pair of the ultrasonic transmitting-receiving means 40 may be provided to both of the pair of the upper and lower sensor cases 20, 30.

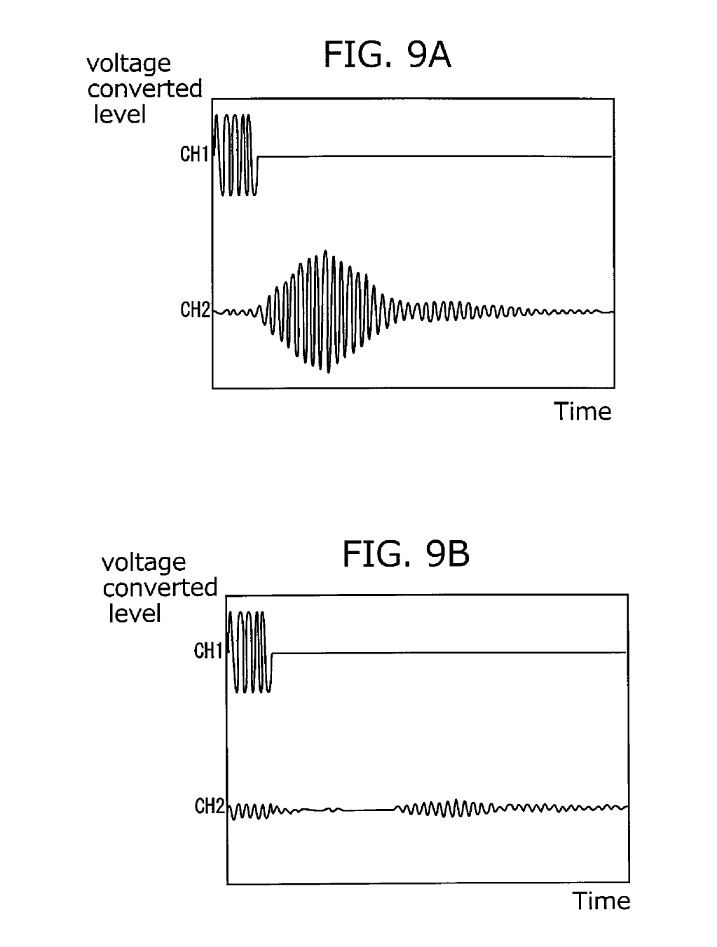

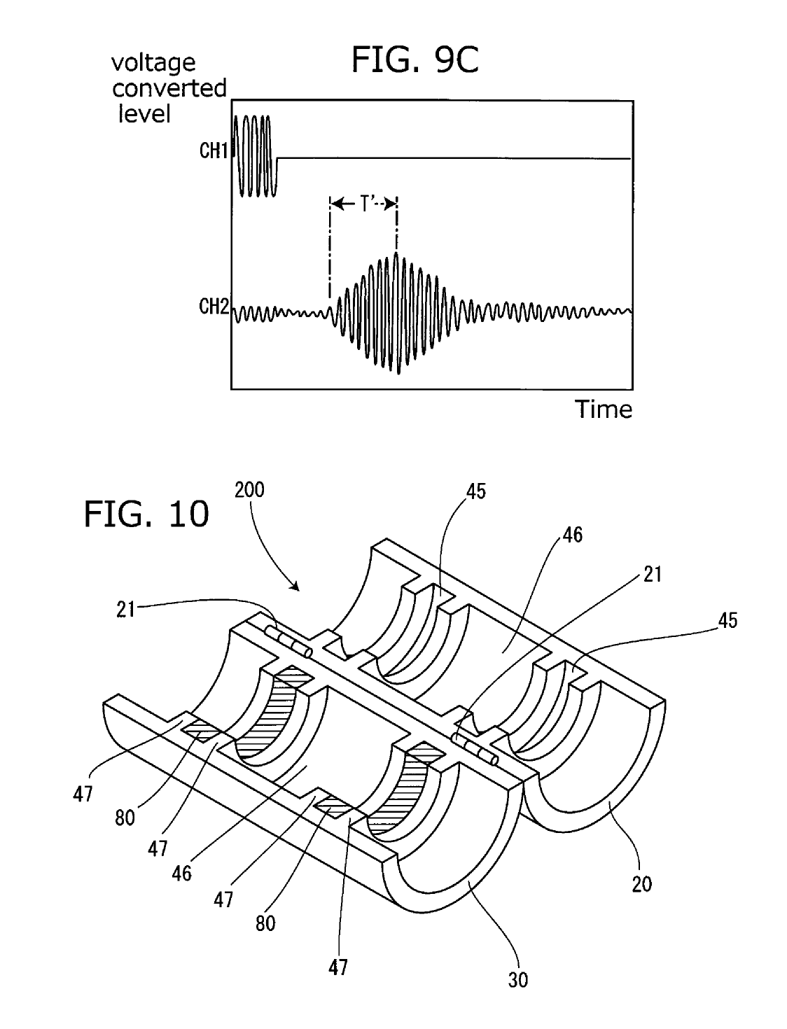

In the embodiment mentioned above, the structure of the pair of the sensor cases 20, 30 to which the ultrasonic transmitting-receiving means 40 is arranged must be devised so as to control the propagation of the ultrasonic wave within the case. That is, attention must be given to the fact that the upper and lower sensor cases 20, 30 functions as a housing for accommodating the ultrasonic transmitting-receiving means 40, and simultaneously becomes a medium for propagating the ultrasonic wave. That is, by merely arranging the ultrasonic transmitting-receiving means 40 to the lower sensor case 30, unnecessary propagating waves transmitted through the case exists, with respect to the reaching time position of the proper propagating wave propagating through the medium inside the tube which contributes to the measurement of the flow velocity, as is shown in FIG. 9A, FIG. 9B, and FIG. 9C, so that the measurement of the reaching time of the proper propagating wave is disturbed. As such, it is necessary to sharply distinguish the proper propagating wave, by controlling the unnecessary propagating wave transmitted through the case. As one specific method for controlling the propagation of the ultrasonic wave transmitting through the case, a means for deleting or attenuating the unnecessary propagating waves is necessary.

One embodiment of the present invention is characterized by being capable of sharply distinguishing the proper propagating wave and the unnecessary propagating wave, by equipping an attenuating means of the propagating wave of the ultrasonic wave transmitting through the case. As a result, as is shown in FIG. 9C, the unnecessary propagating wave propagating through the case is deleted. So that, in the case where the medium is filled in the tube and the flow velocity thereof is measured, it becomes possible to remove the influence of the propagating wave through the case, at the reaching time position of the propagating waves propagated in the medium, and is capable of detecting by sharply distinguishing the proper propagating waves necessary for detecting the flow velocity from the unnecessary propagating waves as is shown in FIG. 9C. This includes the case where the unnecessary propagating wave reaches with a delay, so that the unnecessary propagating wave does not reach the reaching time position of the proper propagating wave.

An outline of a principle of a propagating wave control during the flow velocity measurement of the medium flowing inside the tube will be explained, with reference to FIG. 9A, FIG. 9B and FIG. 9C. FIG. 9A shows waveforms measuring a propagation time relationship between the transmitting wave and the receiving signal, in the case where an ultrasonic wave attenuating means 50 and the like are not provided to the sensor case. Channel 1 (CH1) is a transmitting wave from the ultrasonic transmitting-receiving means 40 (exemplified as a sine wave five-wave in a burst signal), channel 2 (CH2) indicates a signal received by the other ultrasonic transmitting-receiving means 40, and the axis of abscissa indicates time and the axis of ordinate indicates a voltage converted level of each channel. The transmitted signal of the channel 1 (CH1) propagated between the distance L between the two elements (FIG. 1) and received is indicated as the channel 2 (CH2), and the time corresponding to the axis of abscissa becomes the propagating time from the transmitting element to the receiving element. As such, FIG. 9A exemplifies the transmitting-receiving signal waveforms in the case where the ultrasonic wave attenuating means 50 for controlling the propagating waves is not provided. Therefore, the receiving waveform of CH2 is a mixture of the proper ultrasonic wave propagated through the fluid medium within the tube, and the unnecessary ultrasonic wave propagated within the sensor case 30.

FIG. 9B indicates waveforms (channel 2 (CH2)) when the ultrasonic wave is propagated inside the sensor case, in the case where the ultrasonic wave attenuating means 50 and the like which controls the propagating waves is formed in the lower sensor case 30, and in the case where no fluid medium exist in the tube 10. In this case, it is admitted that no large receiving signal exists at the time position corresponding to the proper receiving wave recognized in FIG. 9A, even with the transmitting wave of the channel (CH1). That is, it shows that unnecessary ultrasonic signals propagating through the sensor case may be attenuated and prevented at the reaching time position of the ultrasonic signal propagating through the fluid medium, by providing the ultrasonic wave attenuating means 50 and the like.

FIG. 9C shows, in the case where the ultrasonic wave attenuating means 50 and the like for controlling the propagating waves is formed in the case sensor 30, similarly to the exemplification in FIG. 9B, the receiving signal propagated through the fluid medium in the channel 2 (CH2), when the fluid medium is filled in the tube 10, and the transmitting signal (CH1) from the ultrasonic transmitting-receiving means 40 is flown therein. In this case, it should be perceived that the unnecessary receiving signal (CH2) propagating through the sensor case shown in FIG. 9B is synergized, however, it is apparent that the signal wave at the time position shown by a time position T′ of the receiving signal (CH2) in FIG. 9C includes only the proper ultrasonic wave signal propagated through the medium inside the tube. As such, it clearly indicates the effect of providing the ultrasonic wave attenuating means 50 and the like which controls the propagating wave to the sensor case.

The present invention provides a means which is capable of accurately performing the flow velocity measurement, by measuring and calculating taking a portion corresponding to T′ of the proper ultrasonic signal wave propagated through the medium inside the tube, from the signal of channel 2 (CH2) in FIG. 9C received as is explained above, as the detection target.

Therefore, Embodiment 1 of the present invention (FIG. 1 and FIG. 3A) is characterized in providing the ultrasonic wave attenuating means 50 for controlling the propagation of the ultrasonic wave, at an intermediate portion of the pair of the ultrasonic transmitting-receiving means 40. Specifically, the ultrasonic wave attenuating means 50 is configured from an attenuating groove 50 formed in the lower sensor case 30. The reason for explaining the ultrasonic attenuating means and the attenuating groove using the same reference number is that, the attenuating groove of a groove-like spatial portion is formed by removing the material of the sensor case, so that the subject portion is the same, and this functions as the ultrasonic attenuating means which controls the propagation of the ultrasonic wave. By doing so, when an ultrasonic wave a transmitted from one of the ultrasonic transmitting-receiving means 40 travels to the other ultrasonic transmitting-receiving means 40 by propagating through the upper and lower sensor cases 20, 30, a propagating wave a is greatly attenuated by the ultrasonic wave attenuating means 50 (a groove-like spatial portion), so that there is no problem in measuring a proper propagating wave c propagating through the medium inside the tube. FIG. 3A shows the state where the actual ultrasonic wave a propagating through the lower sensor case 30 is in a state shown by the dotted line and attenuated by the presence of the ultrasonic wave attenuating means 50. In the explanatory view of an operating state shown in FIG. 3A, an operating state in which the ultrasonic transmitting-receiving means 40 on an upstream side of a flow direction A of the medium inside the tube transmits, and the ultrasonic transmitting-receiving means 40 on a downstream side receives. However, it is the same in the case where the ultrasonic transmitting-receiving means 40 on the downstream side of the flow direction A of the medium inside the tube transmits, and the ultrasonic transmitting-receiving means 40 on the upstream side receives.

As is explained above, the same reference number 50 is used to explain the ultrasonic attenuating means, the attenuating groove, and the groove-like spatial portion, however, any structural means may be used as long as it is a means formed in a path of the ultrasonic wave and which is capable of attenuating or suppressing by controlling the propagation of the ultrasonic wave propagated in the sensor case from one of the ultrasonic transmitting-receiving means 40 to the other ultrasonic transmitting-receiving means 40 that is unnecessary for the measurement of the flow velocity. That is, it should be a means which is capable of attenuating, reducing or suppressing the above-mentioned ultrasonic wave, at the time position when the receiving signal of the ultrasonic wave propagating through the medium inside the tube 10 is reached.

Embodiments other than using the attenuating groove may utilize a foam or a Japanese paper filled in the attenuating groove 50. According to such example, it becomes possible to at least slightly increase the rigidity of the sensor case. In addition, voids existing in the foam or the Japanese paper are equipped with a function of attenuating the propagation of the ultrasonic wave. An applied embodiment of the embodiment will be explained later as Embodiment 5.

It is essential to provide the ultrasonic wave attenuating means 50 to the lower sensor case 30 provided with the pair of the ultrasonic transmitting-receiving means 40. It is more preferable to form an ultrasonic wave attenuating means 60 of a similar configuration to the upper sensor case 20, from the viewpoint of propagation of the ultrasonic wave to the tube. Further, the annular void portions 45 may be formed to a position of the upper sensor case 20 corresponding to the pair of the ultrasonic transmitting-receiving means 40 provided to the lower sensor case 30, so that the ultrasonic wave does not directly propagate to the upper sensor case 20 when the upper and lower sensor cases 20, 30 are closed. By doing so, the direct propagation of the ultrasonic wave from the ultrasonic transmitting-receiving means 40 to the upper sensor case 20 may be greatly suppressed. In order to improve the effect of suppressing propagation of the ultrasonic wave, the foam or the Japanese paper may be filled in the annular void portions 45. In the present specification, explanation is given on the latter embodiment.

Further, since the ultrasonic wave attenuating means 50 is formed in the sensor case between the pair of the ultrasonic transmitting-receiving means 40, in the condition of shielding the propagating path of the ultrasonic wave vertically to a tube axial direction of the tube 10, it has a function of delaying the propagating time of the ultrasonic wave. That is, FIG. 3A shows a condition where the propagating path of the ultrasonic wave b of the solid line is greatly detoured by the presence of the ultrasonic wave attenuating means 50. By doing so, the arrival time of the unnecessary ultrasonic wave b propagating in the lower sensor case 30 deviates from the proper propagating wave c, so that it does not provide adverse effect on the measurement of the proper propagating wave c. That is, unnecessary propagating wave transmitted through the sensor case at the time position in which the receiving signal of the proper ultrasonic wave propagating through the medium inside the tube 10 is reached does not exist.

### Embodiment 2

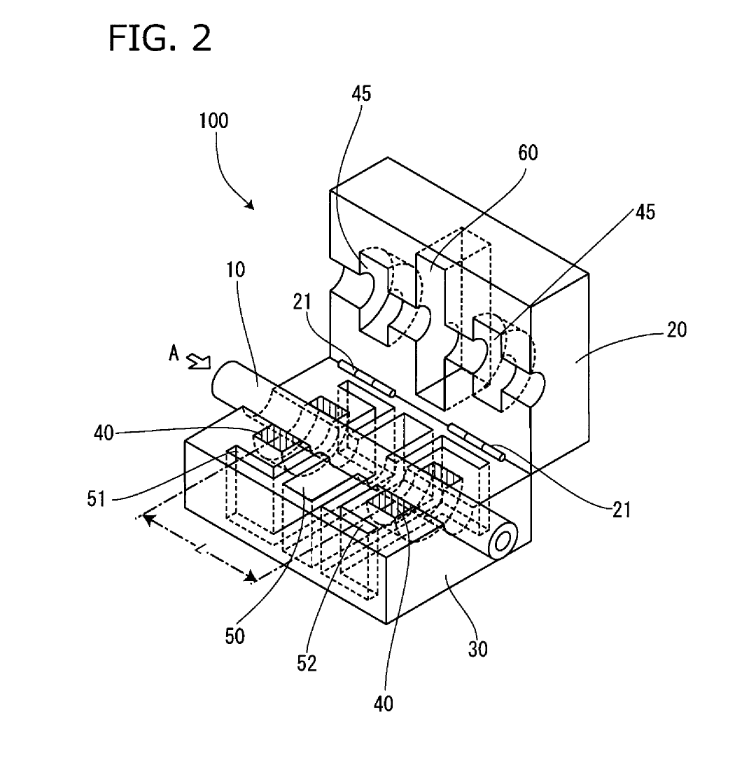

Subsequently, Embodiment 2 of the present invention will be explained with reference to FIG. 2 and FIG. 3B. Explanation will be given using the same reference numbers, to means and the like having similar function as in Embodiment 1. In Embodiment 2, similar to Embodiment 1, the lower sensor case 30 is equipped with the pair of the ultrasonic transmitting-receiving means 40, and a first ultrasonic attenuating means 50 is equipped at an intermediate portion between the pair, and the upper sensor case 20 is provided with a pair of the annular void portions 45 at the position corresponding to the pair of the ultrasonic transmitting-receiving means 40. The first ultrasonic wave attenuating means 50 is, similarly to Embodiment 1, specifically configured from the attenuating groove 50 formed at the lower sensor case 30. The attenuating groove 50 is formed from the groove-like spatial portion 50 by removing the material of the sensor case. Embodiment 2 of the present invention is characterized by providing, in addition to the first ultrasonic wave attenuating means 50, second ultrasonic wave attenuating means 51, 52 to the lower sensor case 30. The second ultrasonic wave attenuating means 51, 52 are configured by attenuating grooves 51, 52 formed in a shape surrounding the pair of the ultrasonic transmitting-receiving means 40 embedded to the lower sensor case 30. Specifically, similarly to the first ultrasonic wave attenuating means 50, groove-shaped spatial portions 51, 52 are formed by removing the material of the lower sensor case 30. The ultrasonic wave attenuating means, the attenuating groove, and the groove-shaped spatial portion are provided with the same reference numbers, since the subject portion are the same.

By doing so, as is shown in FIG. 3B, when the ultrasonic wave a transmitted from one of the ultrasonic transmitting-receiving means 40 propagates through the lower sensor case 30 and travels to the other of the ultrasonic transmitting-receiving means 40, the propagating wave a is further greatly attenuated by the first ultrasonic wave attenuating means (the groove-like spatial portion) 50 and the second ultrasonic wave attenuating means (the groove-like spatial portions) 51, 52. Further, the propagating wave b propagating through the lower sensor case 30 largely detours, so that there is no problem in measuring the proper propagating wave c propagating through the medium within the tube. FIG. 3B shows the situation where the ultrasonic wave a of the solid line is in a state shown by the dotted line and attenuated by the presence of the first ultrasonic wave attenuating means 50 and the second ultrasonic wave attenuating means 51, 52, and the ultrasonic wave b of the solid line detours. Any means may be used as the ultrasonic wave attenuating means, the attenuating groove and the groove-like spatial portion, as long as it is a means formed in a path of the ultrasonic wave propagated through the sensor case from one of the ultrasonic transmitting-receiving means 40, and controls the ultrasonic wave by attenuating or detouring the propagation of the ultrasonic wave. As an embodiment other than the attenuating groove, similarly to Embodiment 1, it may be the one in which the foam or the Japanese paper are filled in the attenuating groove. By doing so, it becomes possible to increase the rigidity of the sensor case even if only slightly. In addition, the voids existing in the foam or the Japanese paper are equipped with a function of attenuating the propagation of the ultrasonic wave.

It is essential to form the first ultrasonic wave attenuating means 50 to the lower sensor case 30 arranged with the pair of the ultrasonic transmitting-receiving means 40. It is more preferable to form the ultrasonic wave attenuating means 60 of a similar configuration to the upper sensor case 20. In this case, the first ultrasonic wave attenuating means is formed from both of the ultrasonic wave attenuating means 50 of the lower sensor case 30 and the ultrasonic wave attenuating means 60 of the upper sensor case 20. Further, the annular void portions 45 are formed to a position of the upper sensor case 20 corresponding to the pair of the ultrasonic transmitting-receiving means 40 provided to the lower sensor case 30, so that the ultrasonic wave does not directly propagate to the upper sensor case 20 when the upper and lower sensor cases 20, 30 are closed. By doing so, the direct propagation of the ultrasonic wave from the ultrasonic transmitting-receiving means 40 in the lower sensor case 30 to the upper sensor case 20 may be greatly suppressed. In order to further improve the effect of suppressing propagation of the ultrasonic wave, the foam or the Japanese paper may be filled in the annular void portions 45.

In FIG. 2, the second ultrasonic wave attenuating means 51, 52 are provided to the lower sensor case 30, but are not provided to the upper sensor case 20. This is because the propagation of the ultrasonic waves a and b within the lower sensor case 30 mounted with the pair of the ultrasonic transmitting-receiving means 40 mainly influences the measurement of the proper propagating ultrasonic wave c. As such, the embodiment in which the second ultrasonic wave attenuating means 51, 52 are provided only to the lower sensor case 30 is illustrated in FIG. 2. However, in order to further improve the attenuating effect of ultrasonic waves, it may be easily performed by the person skilled in the art to provide similar second ultrasonic wave attenuating means 51, 52 to the upper sensor case 20.

Further, in FIG. 2, the second ultrasonic wave attenuating means 51, 52 are provided in a U-shape or an upside-down U-shape, so as to surround the ultrasonic transmitting-receiving means 40. However, it goes without saying that the specific shape is not limited to that shown in FIG. 2. For example, shapes configured to surround the ultrasonic transmitting-receiving means 40, such as a semi-circular shape, a circular arc shape, a crescent shape, a boomerang shape, exert the effect. By doing so, as is shown in FIG. 3B, the second ultrasonic wave attenuating means 51, 52 are formed surrounding the pair of the ultrasonic transmitting-receiving means 40. As such, in the sensor case, they are formed in the state of shielding the propagating path of the ultrasonic wave vertically to the tube axial direction of the tube 10, and have the effect of greatly delaying the propagating time of the ultrasonic wave b propagating through the sensor case. That is, FIG. 3B shows a situation where the ultrasonic wave a of the solid line is attenuated by the first ultrasonic wave attenuating means 50 and the second ultrasonic wave attenuating means 51, 52, and the propagating path of the ultrasonic wave b of the solid line is greatly detoured by the presence of the first ultrasonic wave attenuating means 50 and the second ultrasonic wave attenuating means 51, 52. By doing so, the reaching time of the ultrasonic wave b propagating through the lower sensor case 30 departs, so that it does not give adverse influence to the measurement of the proper propagating wave c. That is, the ultrasonic wave b propagating through the sensor case does not reach the time position in which the receiving signal of the proper ultrasonic wave c propagating through the medium within the tube is reached.

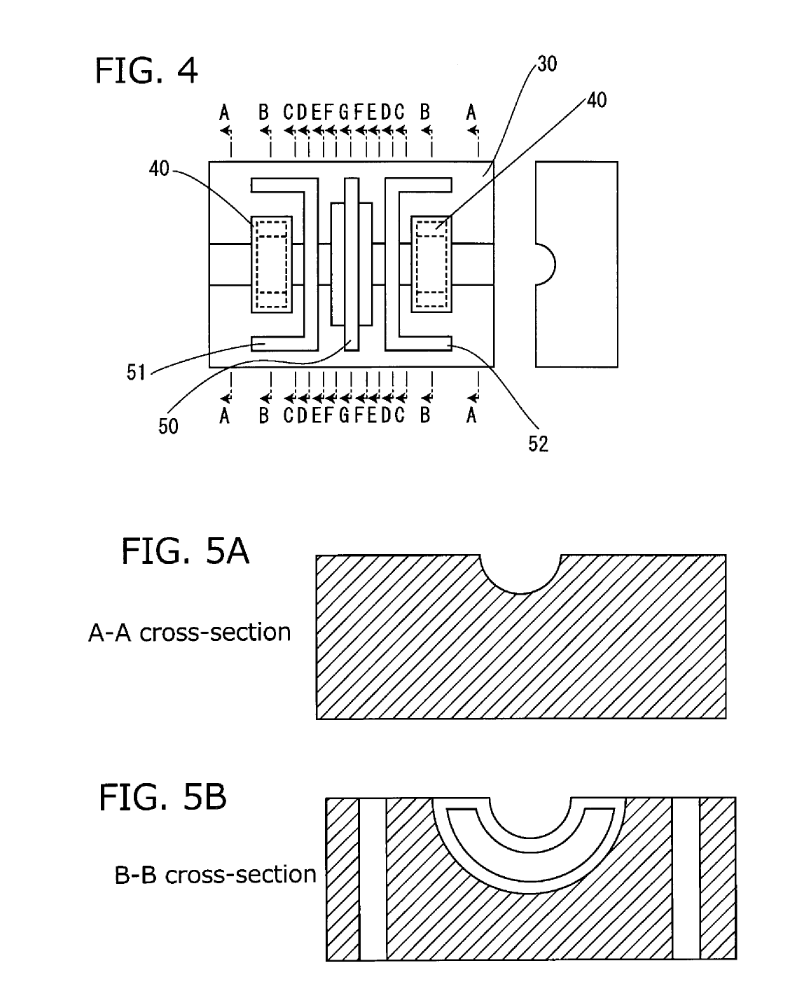

Further, a detailed structure of Embodiment 2 will be explained with reference to FIG. 4. FIG. 4 shows a planar configuration of the lower sensor case 30. Similarly to FIG. 2 and FIG. 3B, the pair of the ultrasonic transmitting-receiving means 40 is provided with a predetermined distance apart, and the first ultrasonic wave attenuating means 50 and the second ultrasonic wave attenuating means 51, 52 are provided between the pair. As the first ultrasonic wave attenuating means 50, a deeper groove-like spatial portion is provided to the center thereof, unlike that in FIG. 2 and FIG. 3B.

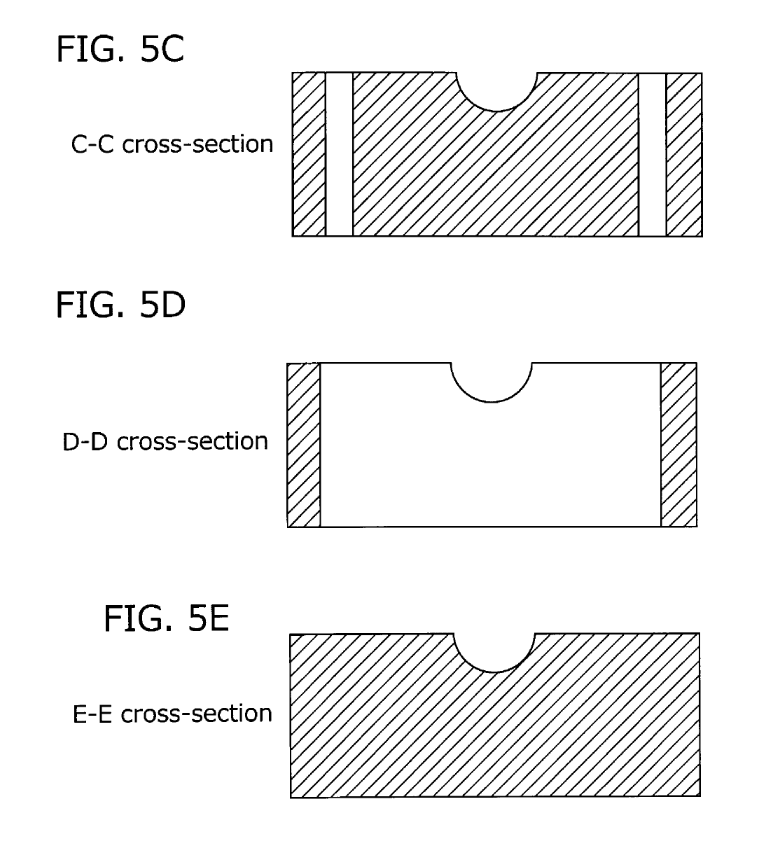

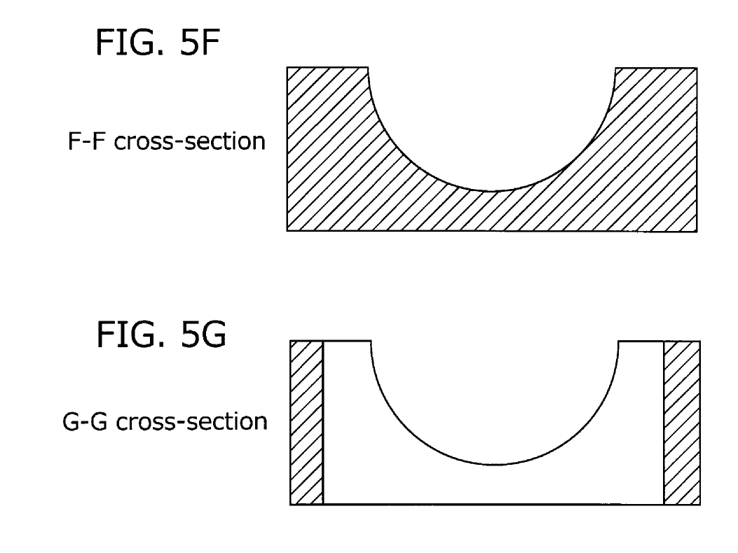

FIG. 5A through FIG. 5G are cross-sectional detailed constructional views of the lower sensor case 30 provided with the first and the second ultrasonic wave attenuating means of Embodiment 2 of the present invention shown in FIG. 4, and have a symmetric arrangement taking a G-G cross-section as a center.

### Embodiment 3

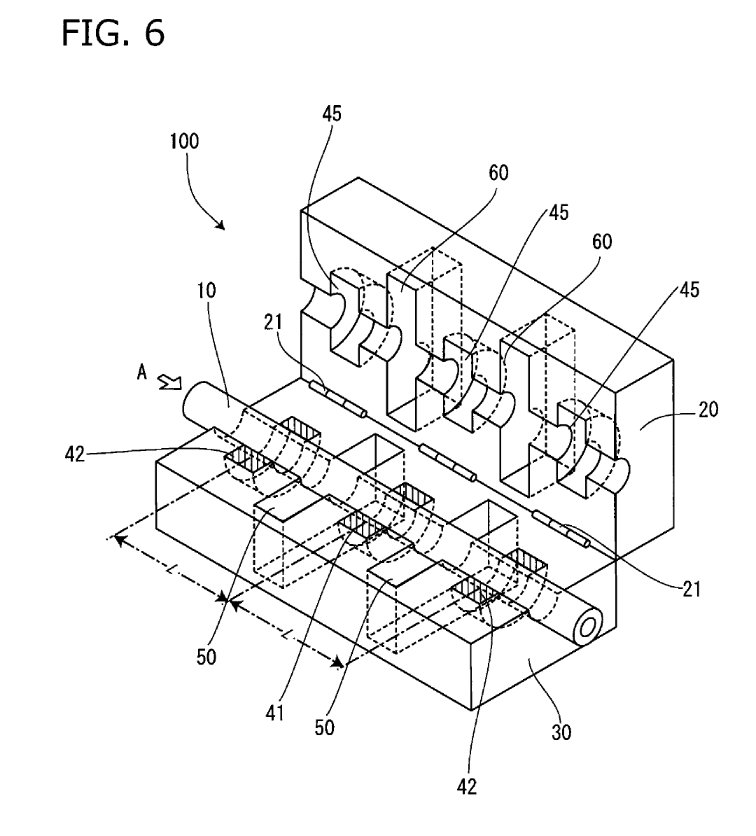

Subsequently, as Embodiment 3 of the present invention, a three-element type ultrasonic flow rate measuring device and ultrasonic flow rate measuring method will be explained. The one shown in Patent Document 1 proposes a two-element type, similarly to Embodiment 1 or Embodiment 2. The three-element type ultrasonic flow rate measuring device is shown in FIG. 6 through FIG. 8.

First, explanation will be given on the operating principle of the three-element type. The operating principle of the two-element type is as follows: the pair of the ultrasonic transmitting-receiving means 40 is arranged on the axis of the tube 10 in which the medium flows with a predetermined interval L therebetween; the other one of the element receives the ultrasonic signal transmitted from the one element and propagated through the medium; the transmitting element and the receiving element are switched to respectively detect the signal propagating through the flowing direction A of a fluid medium and the signal propagating against the flowing direction A, so as to detect the time difference of the propagating wave from the upstream side element and the propagating wave from the downstream side element; the flow velocity of the medium calculated from the time difference is obtained; and the flow rate is calculated and displayed by multiplying the inner diameter cross-sectional area of the tube to the flow velocity.

On the other hand, the operating principle of the three-element type is as follows: one ultrasonic transmitting means 41 is arranged at the center, and two ultrasonic receiving means 42, are arranged at both sides thereof on the axis of the tube 10 with a predetermined interval L therebetween, respectively; the central ultrasonic transmitting element 41 transmits the ultrasonic wave, so as to propagate through the flow A of the medium within the tube to both of the ultrasonic receiving elements 42, on the upstream side and the downstream side; and the ultrasonic receiving element 42 arranged on the upstream side (the element on the left side in FIG. 6) acquires the ultrasonic signal propagating against the flow of the fluid medium, and the ultrasonic receiving element 42 arranged on the downstream side (the element on the right side in FIG. 6) acquires the ultrasonic signal propagating along the flow A of the fluid medium. By doing so, the reaching time of the propagating wave to the upstream side and the propagating wave to the downstream side may be measured simultaneously, without switching the transmitting/receiving as is in the two-element type. Therefore, the three-element type has a characteristics that the switching means is not necessary. A measuring principle itself of the flow velocity by this type is disclosed in Patent Document 4.

The ultrasonic flow meter 100 of Embodiment 3 disclosed in FIG. 6 through FIG. 8 is, similarly to Embodiment 1 and Embodiment 2, configured from the upper and lower sensor cases 20, 30. The upper and lower sensor cases 20, 30 are configured so as to be freely opened and closed by the hinge 21. When the upper and lower sensor cases 20, 30 are closed, the upper and lower sensor cases 20, 30 clamps the tube 10 in which the fluid medium to be measured flows from above and below. In one sensor case of the upper and lower sensor cases 20, 30 (in Embodiment 3 shown in FIG. 6, the lower sensor case 30), three semi-annular ultrasonic transmitting-receiving means are embedded with the predetermined distance L apart from each other. Of the three ultrasonic transmitting-receiving means, the central element 41 transmits the ultrasonic wave as the transmitting means, and the two elements 42 arranged on both sides function as the receiving means.

With such configuration, on the basis of the operating principle of the three-element type explained above, the flow velocity of the medium flowing inside the tube 10 may be detected, by transmitting and receiving the ultrasonic wave between the central ultrasonic transmitting means 41 and the pair of the ultrasonic receiving means 42 arranged on the upstream side and the downstream side.

Even in Embodiment 3, attention must be given to the fact that the upper and lower sensor cases 20, 30 functions as a housing for accommodating the three ultrasonic transmitting-receiving means, and simultaneously becomes a medium for transmitting the ultrasonic wave. That is, by merely arranging the ultrasonic transmitting-receiving means to the lower sensor case 30, unnecessary propagating waves a and b transmitted through the case exists, with respect to the reaching time position of the proper propagating wave c propagating through the medium inside the tube which is the object of the measurement of the flow velocity, as is shown in FIG. 9A, FIG. 9B, and FIG. 9C, so that the measurement is disturbed. As such, it is necessary to provide the ultrasonic wave attenuating means for deleting or attenuating the unnecessary propagating waves a and b transmitting through the case. The ultrasonic wave attenuating means controls propagation of the ultrasonic wave.

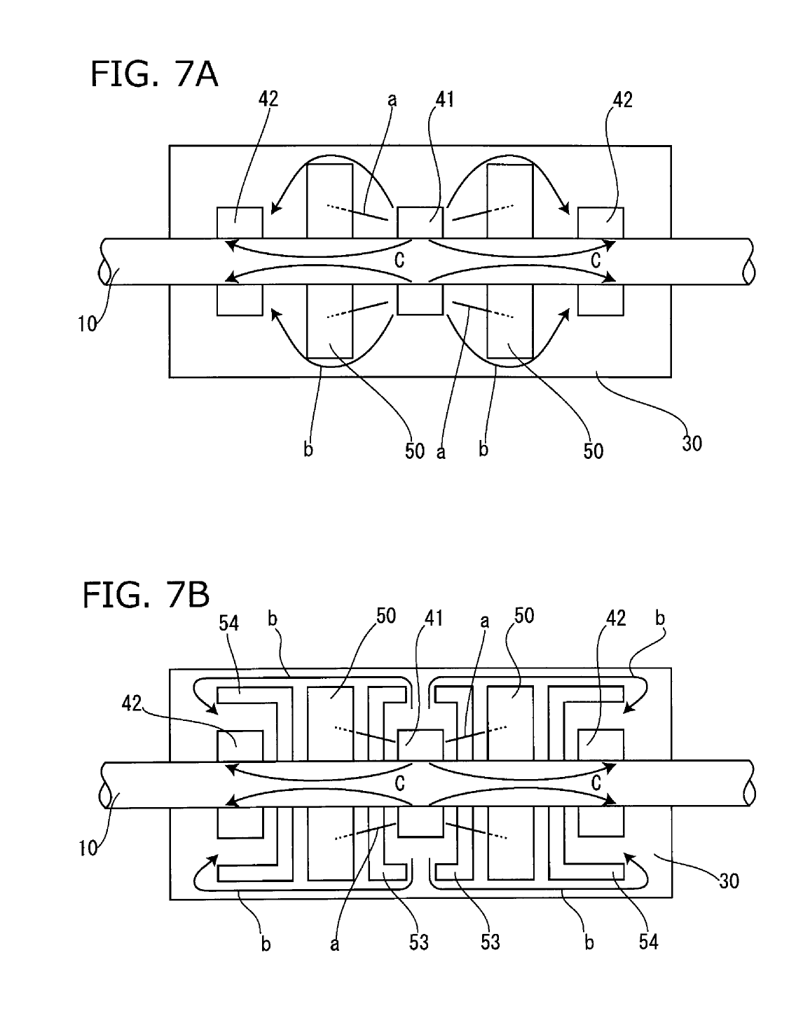

Therefore, Embodiment 3 of the present invention is characterized in providing a pair of attenuating means 50 of the ultrasonic wave between the three ultrasonic transmitting-receiving means, respectively. The ultrasonic wave attenuating means 50 is, specifically, configured from the attenuating groove 50 formed at the lower sensor case 30. The attenuating groove 50 is formed by removing the material of the sensor case so as to form the groove-like spatial portion 50. By doing so, when the ultrasonic wave a transmitted from the ultrasonic transmitting means 41 arranged at the center propagates through the lower sensor case 30 and travels to the ultrasonic receiving means 42 arranged on both sides, the ultrasonic wave a is attenuated by the ultrasonic wave attenuating means (the groove-like spatial portion) 50. Or, the ultrasonic wave b transmitted from the ultrasonic transmitting means 41 is detoured, so that there is no problem in measuring the proper propagating wave c propagating through the medium inside the tube. FIG. 7A shows the situation where the ultrasonic wave a is in a state shown by the dotted line and attenuated by the presence of the ultrasonic wave attenuating means 50, and the situation where the ultrasonic wave b of the solid line detours by the presence of the ultrasonic wave attenuating means 50. The same reference number 50 is used to explain the ultrasonic attenuating means, the attenuating groove, and the annular spatial portion, because they represent the same portion. However, any structural means may be used as long as it is a means formed in a path of the ultrasonic wave and which is capable of attenuating or absorbing the propagation of the ultrasonic wave propagating through the sensor case from the central ultrasonic transmitting means 41 to the ultrasonic receiving means 42 on both sides. That is, it should be a means which is capable of avoiding the arrival of unnecessary ultrasonic wave propagating through the sensor case, at the time position when the proper receiving signal of the ultrasonic wave propagating through the medium inside the tube 10 is reached.

Embodiments other than the attenuating groove may adopt a foam or a Japanese paper filled in the attenuating grooves 50. By such arrangement, it becomes possible to increase the rigidity of the sensor case even if only slightly. In addition, voids existing in the foam or the Japanese paper are equipped with a function of attenuating the propagation of the ultrasonic wave.

It is essential to provide the ultrasonic wave attenuating means 50 to the lower sensor case 30 provided with the three ultrasonic transmitting-receiving means. It is more preferable to form the ultrasonic wave attenuating means 60 of a similar configuration to the upper sensor case 20, to further improve the attenuation effect of the ultrasonic wave. Further, the annular void portion 45 may be formed to a position of the upper sensor case 20 corresponding to the three ultrasonic transmitting-receiving means provided to the lower sensor case 30, so that the ultrasonic wave does not directly propagate to the upper sensor case 20 when the upper and lower sensor cases 20, 30 are closed. By doing so, the direct propagation of the ultrasonic wave from the ultrasonic transmitting means 41 to the upper sensor case 20 toward the pair of the ultrasonic receiving means 42 may be greatly suppressed. The foam or the Japanese paper may be filled in the annular void portion 45. Although the three ultrasonic transmitting-receiving means are provided only to the lower sensor case 30 in Embodiment 3 shown in FIG. 6, it could obviously be provided also to the upper sensor case 20.

Further, since the ultrasonic wave attenuating means 50 is formed in the sensor case between each of the three ultrasonic transmitting-receiving means, in the condition of shielding the propagating path of the ultrasonic wave vertically to the tube axial direction of the tube 10, it has a function of delaying the propagating time of the ultrasonic wave b propagating from the ultrasonic transmitting means 41 to the both ultrasonic receiving means 42. That is, FIG. 7A shows a condition where the ultrasonic wave a of the solid line attenuates or extinguishes, and the propagating path of the ultrasonic wave b of the solid line is detoured, by the presence of the ultrasonic wave attenuating means 50. By doing so, the ultrasonic wave a propagating in the lower sensor case 30 attenuates, and the arrival time of the ultrasonic wave b propagating in the lower sensor case 30 deviates from the proper propagating wave c, so that they do not provide adverse effect on the measurement of the proper propagating wave c. That is, arrival of the unnecessary propagating wave at the time position in which the receiving signal of the proper ultrasonic wave c which propagates through the medium inside the tube 10 is reached does not exist.

### Embodiment 4

Subsequently, Embodiment 4 of the present invention will be explained with reference to FIG. 7B. Explanation will be given with same reference number, to means and the like having similar function as other Embodiments. In Embodiment 4, similar to Embodiment 3, the lower sensor case 30 is equipped with three ultrasonic transmitting-receiving means, with one ultrasonic transmitting means 41 in the center, and two ultrasonic receiving means 42 at both sides thereof. The first ultrasonic attenuating means 50 is equipped between the ultrasonic transmitting means 41 and each of the ultrasonic receiving means 42. The first ultrasonic wave attenuating means 50 is, similarly to other embodiments, specifically configured from the attenuating groove 50 formed at the lower sensor case 30. The attenuating groove 50 is formed from the groove-like spatial portion 50 by removing the material of the sensor case, so that the explanation will be given using the same reference numbers. Embodiment 4 of the present invention is characterized by providing, in addition to the first ultrasonic wave attenuating means 50, a second ultrasonic wave attenuating means 53 and a third ultrasonic wave attenuating means 54 to the lower sensor case 30. The second ultrasonic wave attenuating means 53 is configured by an attenuating groove 53 formed in a shape surrounding the central ultrasonic transmitting means 41 embedded to the lower sensor case 30. The third ultrasonic wave attenuating means 54 is configured by an attenuating groove 54 formed in a shape surrounding each of the ultrasonic transmitting means 42 on both sides embedded to the lower sensor case 30. Specifically, similarly to the first ultrasonic wave attenuating means 50, attenuating grooves and groove-shaped spatial portions are formed by removing the material of the lower sensor case 30, so that the explanation will be given with same reference number.

By doing so, as shown in FIG. 7B, when the ultrasonic wave a transmitted from the central ultrasonic transmitting means 41 propagates through the lower sensor case 30 and travels to the ultrasonic receiving means 42 arranged on both sides, the propagating wave a propagating through the lower sensor case 30 is greatly attenuated or the propagating wave b is greatly detoured by the first ultrasonic wave attenuating means (the groove-like spatial portion) 50, the second ultrasonic wave attenuating means (the groove-like spatial portion) 53 and the third ultrasonic wave attenuating means (the groove-like spatial portion) 54, so that there is no problem in measuring a proper propagating wave c propagating through the medium inside the tube. FIG. 7B shows the situation where the ultrasonic wave a of the solid line is in a state shown by the dotted line and greatly attenuated by the presence of the first ultrasonic wave attenuating means 50, the second ultrasonic attenuating means 53, and the third ultrasonic wave attenuating means 54, and the situation where the ultrasonic wave b of the solid line detours similarly. Any means may be used as the ultrasonic attenuating means, the attenuating groove, and the annular spatial portion, as long as it is a means formed in a path of the ultrasonic wave and which is capable of attenuating or detouring the propagation of the ultrasonic wave propagating through the sensor case from the central ultrasonic transmitting means 41 to the ultrasonic receiving means 42 on both sides. Embodiments other than the attenuating groove may adopt a foam or a Japanese paper filled in the attenuating grooves similarly to Embodiment 1. According to such arrangement, it becomes possible to increase the rigidity of the sensor case even if only slightly. In addition, voids existing in the foam or the Japanese paper are equipped with a function of attenuating the propagation of the ultrasonic wave.

It is essential to provide the first ultrasonic wave attenuating means 50 to the lower sensor case 30 even when three ultrasonic transmitting-receiving means are provided thereto. It is more preferable to form the ultrasonic wave attenuating means 60 of a similar configuration to the upper sensor case 20, to further improve the attenuation effect of the ultrasonic wave. In this case, the first ultrasonic wave attenuating means is formed by the ultrasonic wave attenuating means 50 of the lower sensor case 30 and the ultrasonic wave attenuating means 60 of the upper sensor case 20. Further, it is preferable to form the annular void portion 45 to a position of the upper sensor case 20 corresponding to the three ultrasonic transmitting-receiving means provided to the lower sensor case 30, so that the ultrasonic wave does not directly propagate to the upper sensor case 20 when the upper and lower sensor cases 20, 30 are closed. By doing so, the direct propagation of the ultrasonic wave from each ultrasonic transmitting means to the upper sensor case 20 may be greatly suppressed. If the foam or the Japanese paper is filled in the annular void portion 45, the attenuating effect of the ultrasonic wave may be enhanced.

Further, in FIG. 7B, the second ultrasonic wave attenuating means 53 and the third ultrasonic wave attenuating means 54 are formed in a U-shape or an upside-down U-shape, so as to surround the central ultrasonic transmitting means 41 and the ultrasonic receiving means 42 on both sides. However, it goes without saying that the specific shape is not limited to that shown in FIG. 7B. For example, shapes configured to surround each ultrasonic transmitting-receiving means, such as a semi-circular shape, a circular arc shape, a crescent shape, a boomerang shape, exert the effect. By doing so, as is shown in FIG. 7B, the second ultrasonic wave attenuating means 53 and the third ultrasonic wave attenuating means 54 are formed surrounding the central ultrasonic transmitting means 41 and the ultrasonic receiving means 42 on both sides. As such, in the sensor case, they are formed in the state of shielding the propagating path of the ultrasonic wave vertically to the tube axial direction of the tube 10, and have the effect of attenuating the ultrasonic wave propagating through the case, and greatly delaying the propagating time thereof. That is, FIG. 7B shows a situation where the ultrasonic wave a of the solid line is greatly attenuated, and the propagating path of the ultrasonic wave b of the solid line is greatly detoured, by the presence of the first ultrasonic wave attenuating means 50, the second ultrasonic wave attenuating means 53, and the third ultrasonic wave attenuating means 54. By doing so, the reaching time of the unnecessary ultrasonic wave b propagating through the lower sensor case 30 departs, so that it does not give adverse effect to the measurement of the proper propagating wave c. As such, there is no arrival of the unnecessary ultrasonic wave at the time position in which the receiving signal of the proper ultrasonic wave c propagating through the medium within the tube is reached.

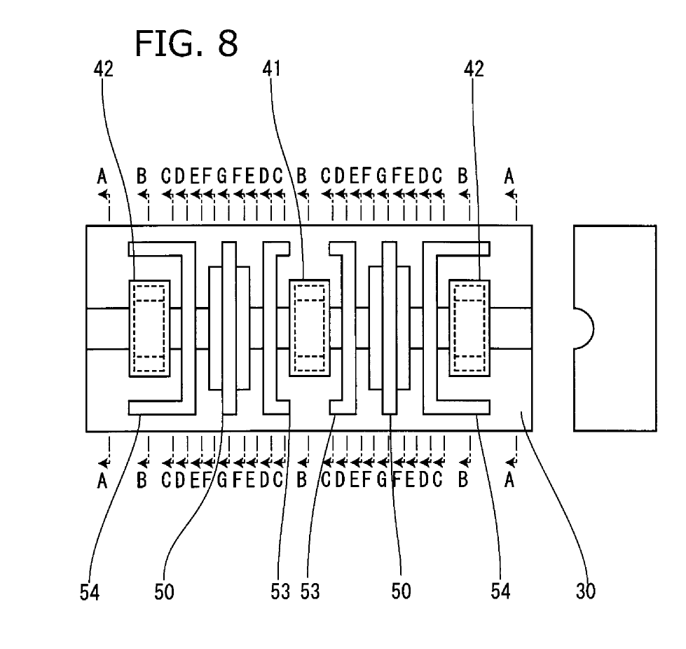

FIG. 8 are constructional views showing detailed arrangement of the first, the second, and the third ultrasonic wave attenuating means 50, 53, 54 in Embodiment 4 of the present invention, and each cross-sectional view is similar to the cross-sectional view shown in FIG. 5A, FIG. 5B, FIG. 5C, FIG. 5D, FIG. 5E, FIG. 5F, and FIG. 5G.

### Embodiment 5

An explanation will be given on Embodiment 5 of the present invention with FIG. 10. An ultrasonic flow meter 200 of Embodiment is, similar to Embodiment 1, configured from a pair of semi-cylindrical upper and lower sensor cases 20, 30. The upper and lower sensor cases 20, 30 are configured so as to be freely opened and closed by a predetermined number of the hinges 21. When the upper and lower sensor cases 20, 30 are closed, the upper and lower sensor cases 20, 30 clamp a tube (not shown) in which a fluid medium to be measured flows, from above and below so as to become cylindrical. The specific structure of the opening-closing means of the upper and lower sensor cases 20, 30 may be arbitrarily changed. To one of the sensor case of the upper and lower sensor cases 20, 30 (in Embodiment 5 of FIG. 10, to the lower sensor case 30) a pair of semi-annular ultrasonic transmitting-receiving means 80 is embedded with a predetermined distance L therebetween. The pair of the ultrasonic transmitting-receiving means 80 is equipped with a transmitting and receiving function of ultrasonic wave, and in the case where one transmits ultrasonic wave as the transmitting means, the other functions as the receiving means, and in the case where the other transmits ultrasonic wave as the transmitting means, the one functions as the receiving means. It is preferable that internal diameter surface of the pair of the semi-annular ultrasonic transmitting-receiving means 80 closely contacts an outer peripheral surface of the tube, when the upper and lower sensor cases 20, 30 are closed. In Embodiment 5 of FIG. 10, the pair of the ultrasonic transmitting-receiving means 80 is provided only to the lower sensor case 30, and a pair of annular void portions is provided to the upper sensor case 20 in a position corresponding to the pair of the ultrasonic transmitting-receiving means 80. The function of the annular void portion 45 is to provide an effect of preventing the ultrasonic wave transmitted from the ultrasonic transmitting-receiving means 80 from propagating to the upper sensor case 20. Although not shown, the ultrasonic transmitting-receiving means 80 may be provided to both of the pair of the upper and lower sensor cases 20, 30.

The ultrasonic transmitting-receiving means 80 is arranged at a part of the outer periphery (for example, semi-annularly) along the outer periphery of the tube. The pair of the sensor cases 20, 30, to which the ultrasonic transmitting-receiving means 80 is embedded, is prepared by molding with a plastic material having a similar hardness with or a slightly harder elastic modulus than a material of the tube. The pair of the sensor cases 20, 30 is made to press the outer periphery of the tube at this molded portion, so as to achieve the contact state, so that when the ultrasonic transmitting-receiving means 80 is driven, a pressure wave, that is, an ultrasonic acoustic field is formed at the medium inside the tube. At this time, it is necessary to closely contact the inner peripheral surface of the ultrasonic transmitting-receiving means 80 and the outer periphery surface of the tube so that no gap is formed therebetween.

In the ultrasonic flow rate measuring device shown in FIG. 10, the pair of the ultrasonic transmitting-receiving means 80 is embedded to only one of the sensor case (in Embodiment 5 of FIG. 10, to the lower sensor case 30), and the other sensor case (in Embodiment 5 of FIG. 10, the upper sensor case 20) is formed so as to be fixed with respect to the tube so that the tube and the ultrasonic transmitting-receiving means 80 closely contacts each other. The fixing means is not specifically limited, and may be achieved by means such as a detachable hook, or a bolting means piercing through the upper and lower sensor cases 20, 30. In any case, it is important to maintain the close contact to the extent that the propagation of the ultrasonic wave between the tube and the pair of the ultrasonic transmitting-receiving means 80 is possible.

As is explained above, in the ultrasonic flow rate measuring device shown in FIG. 10, the annular void portion 45 is formed to a position of the upper sensor case 20 corresponding to the pair of the ultrasonic transmitting-receiving means 80 provided to the lower sensor case 30, so that the ultrasonic wave does not directly propagate to the upper sensor case 20 when the upper and lower sensor cases 20, 30 are closed. By doing so, the direct propagation of the ultrasonic wave from the ultrasonic transmitting-receiving means 80 to the upper sensor case 20 may be greatly suppressed. The annular void portion 45 may be filled with the foam or the Japanese paper, in order to improve the effect of suppressing propagation of the ultrasonic wave. Further, between the pair of the ultrasonic transmitting-receiving means 80 of the lower sensor case 30, and between the pair of the annular void portions 45 of the upper sensor case 20, a large void portion 46 is respectively provided so as to suppress propagation of the ultrasonic wave transmitting through the upper and lower sensor cases 20, 30.

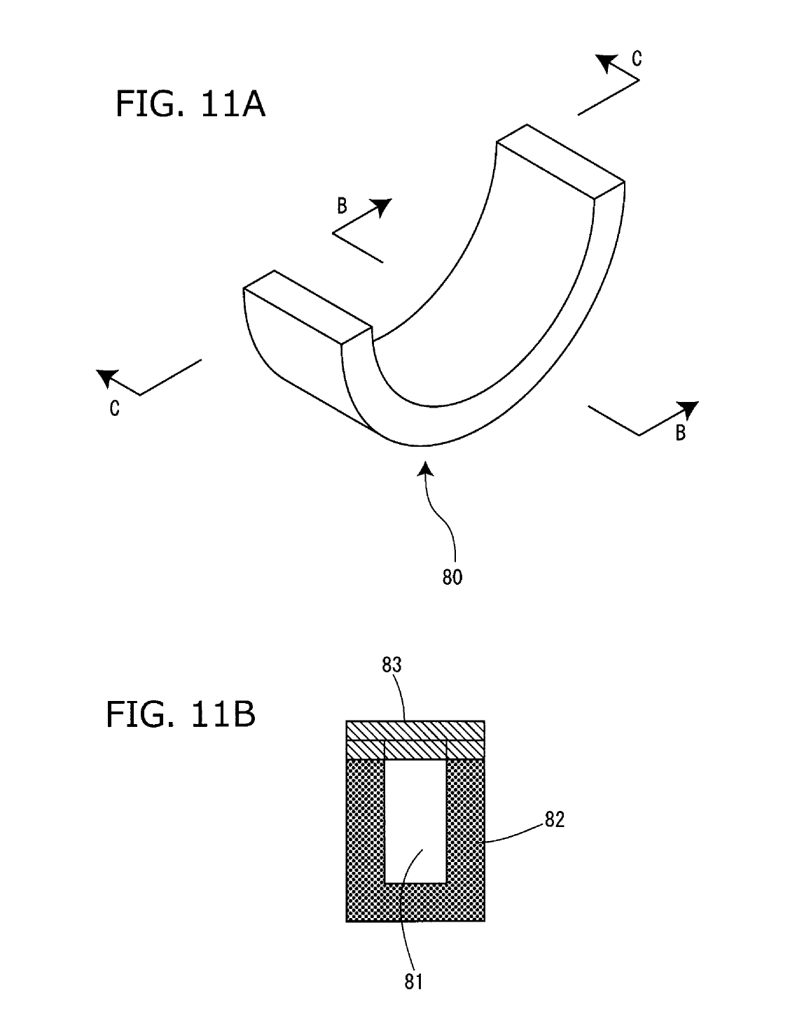

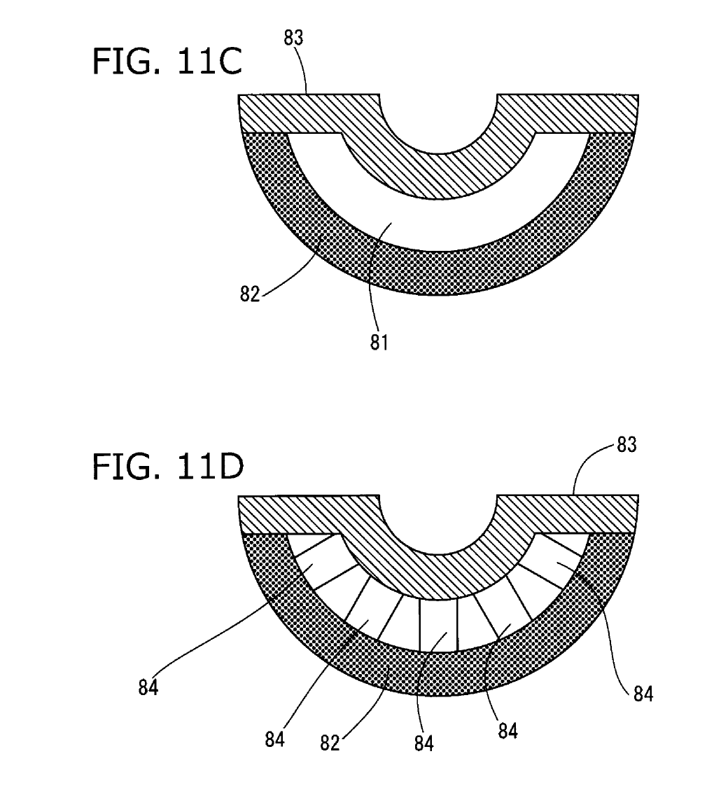

A detailed configuration of the ultrasonic transmitting-receiving means 80 used in Embodiment 5 will be explained with reference to FIG. 11A through FIG. 11D. FIG. 11A shows an overall perspective view of the ultrasonic transmitting-receiving means 80. The ultrasonic transmitting-receiving means 80 has an overall semi-annular shape. As is apparent from FIG. 11B and FIG. 11C, the ultrasonic transmitting-receiving means 80 is arranged with a semi-annular piezo-ceramic element 81 at the interior thereof. Further, an ultrasonic wave propagation suppressing member 82, made of closed-pore foaming resin or Japanese paper and the like, cover the outer peripheral portion of the lower surface and both side surfaces of the piezo-ceramic element 81. The side of the piezo-ceramic element 81 contacting the tube is provided with an acoustic coupling member 83 such as a solid rubber. The ultrasonic wave propagation suppressing member 82 is equipped with a function of suppressing propagation of the ultrasonic wave transmitted from the piezo-ceramic element 81, and the acoustic coupling member 83 is equipped with a function of not suppressing the propagation of the ultrasonic wave transmitted from the piezo-ceramic element 81. The ultrasonic transmitting-receiving means 80 configured as is explained above is arranged in a dent portion formed between a pair of rims 47 formed in the lower sensor case 30. By arranging the pair of the ultrasonic transmitting-receiving means 80 in the dent portion formed between the pair of the rims 47, it becomes possible to accurately arrange the distance between the pair of the ultrasonic transmitting-receiving means 80.

As another configuration of the ultrasonic transmitting-receiving means 80 used in Embodiment 5, FIG. 11D is shown. The ultrasonic transmitting-receiving means 80 of FIG. 11D is identical to the configurations in FIG. 11A through FIG. 11C, in that it is provided with the ultrasonic wave propagation suppressing member 82 made of closed-pore foaming resin or Japanese paper and the like to cover the outer periphery of the piezo-ceramic element, and that the acoustic coupling member 83 such as an solid rubber is provided to the side of the piezo-ceramic element contacting the tube. On the other hand, the characteristic point of the ultrasonic transmitting-receiving means 80 in FIG. 11D is that the piezo-ceramic element is configured from a plurality of divided piezo-ceramic element groups 84. The piezo-ceramic element group 84 of FIG. 11D each has an independent square shape, and a plurality of the same are arrange in an arc shape. By doing so, the semi-annular piezo-ceramic element group 84 as a whole may be configured inexpensively.

### Embodiment 6

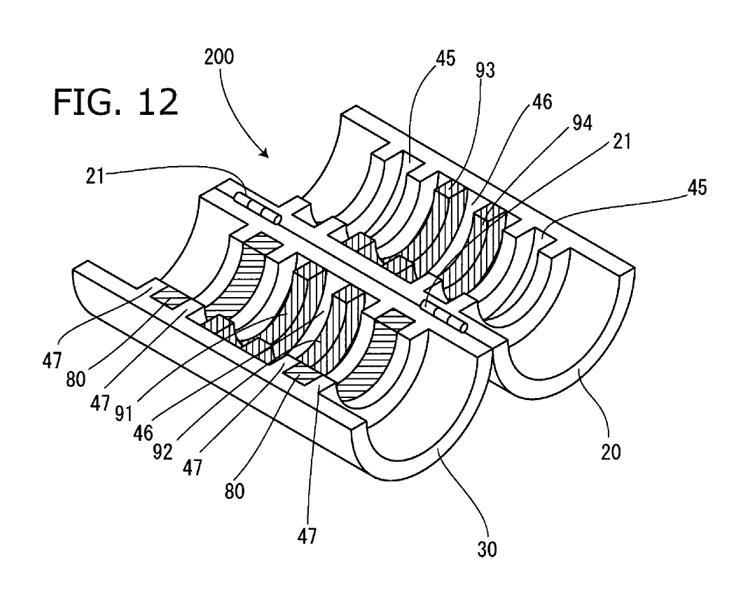

An explanation will be given on Embodiment 6 of the present invention with FIG. 12. The ultrasonic flow meter 200 of Embodiment 6 is configured from a pair of semi-cylindrical upper and lower sensor cases 20, 30 of a configuration similar to Embodiment 5. The upper and lower sensor cases 20, 30 are configured so as to be freely opened and closed by a predetermined number of the hinges 21. When the upper and lower sensor cases 20, 30 are closed, the upper and lower sensor cases 20, 30 clamps a tube (not shown) in which a fluid medium to be measured flows, from above and below so as to become cylindrical. To one of the sensor case of the upper and lower sensor cases 20, 30 (in Embodiment 5 in FIG. 10, to the lower sensor case 30) the pair of semi-annular ultrasonic transmitting-receiving means 80 is embedded with a predetermined distance L therebetween. The pair of the ultrasonic transmitting-receiving means 80 is equipped with a transmitting and receiving function of ultrasonic wave, and in the case where one transmits the ultrasonic wave as the transmitting means, the other functions as the receiving means, and in the case where the other transmits the ultrasonic wave as the transmitting means, the one functions as the receiving means. It is preferable that internal diameter surface of the pair of the semi-annular ultrasonic transmitting-receiving means 80 closely contacts an outer peripheral surface of the tube, when the upper and lower sensor cases 20, 30 are closed. In Embodiment 6 of FIG. 12, similar to Embodiment 5 of FIG. 10, the pair of the ultrasonic transmitting-receiving means 80 is provided only to the lower sensor case 30, and a pair of annular void portions 45 is provided to the upper sensor case 20 in a position corresponding to the ultrasonic transmitting-receiving means 80. The function of the annular void portion 45 is to provide an effect of preventing the ultrasonic wave transmitted from the ultrasonic transmitting-receiving means 80 from propagating to the upper sensor case 20. Although not shown, the ultrasonic transmitting-receiving means 80 may be provided to both of the pair of the upper and lower sensor cases 20, 30.

Further, between the pair of the ultrasonic transmitting-receiving means 80 of the lower sensor case 30, and between the pair of the annular void portions 45 of the upper sensor case 20, the large void portion 46 is respectively provided. And, flanges 91, 92 and 93, 94 exerting an acoustic filter effect and having a substantially identical shape as the ultrasonic transmitting-receiving means 80 are provided inside the void portion 46. The flanges exerting the acoustic filter are adhered or fixed to the inner periphery of the upper and lower sensor cases.

The technique of the acoustic filter is explained earlier in Patent Document 5, as the effect of the flange fixed to the measurement tube as the acoustic filter. In Embodiment 6, the flanges 91, 92 and 93, 94 having such acoustic filter effect are provided, and suppress the propagation of the ultrasonic wave transmitting through the upper and lower sensor cases 20, 30 thereby.

Further, in the ultrasonic flow meter 200 of Embodiment 6, the flanges 91, 92 and 93, 94 are configured from a magnetic material. By doing so, no special opening and closing means of the upper and lower sensor cases 20, 30 becomes necessary, and the upper and lower sensor cases 20, 30 may strongly clamp the tube by the absorption power of the magnetic of the flanges 91, 92 and 93, 94. Upon removal of the upper and lower sensor cases 20, 30, it may be easily removed by opening with the force against the absorption power of the magnet.

### Embodiment 7

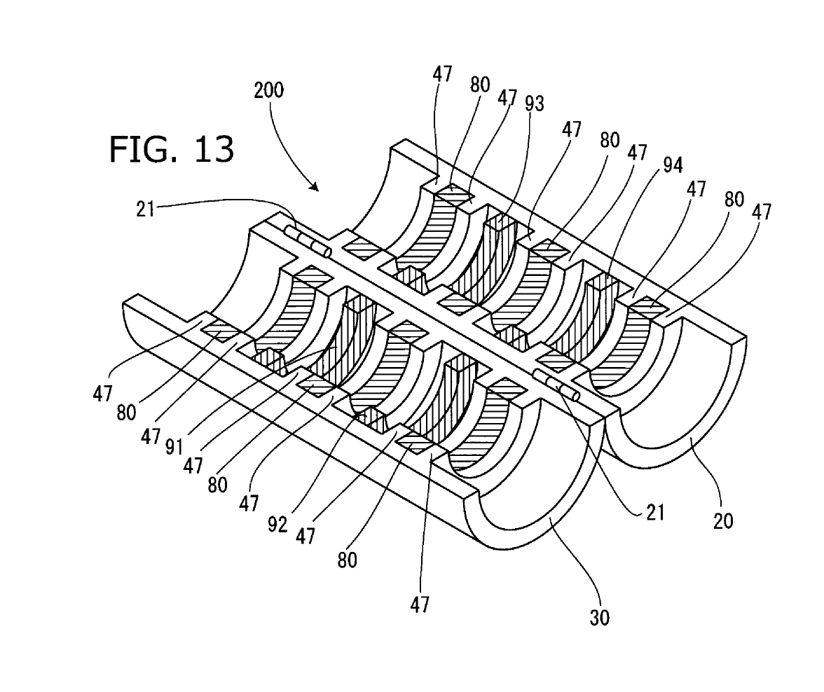

An explanation will be given on Embodiment 7 of the present invention with FIG. 13. The ultrasonic flow meter 200 of Embodiment 7 is configured from a pair of semi-cylindrical upper and lower sensor cases 20, 30, similarly to Embodiment 6. The difference from Embodiment 6 is in the point that three ultrasonic transmitting-receiving means 80 are provided, similarly to Embodiment 3 (FIG. 6), in which the central ultrasonic transmitting-receiving means 80 is made to be the ultrasonic transmitting element, and the ultrasonic transmitting-receiving means 80 on both sides are made to be the ultrasonic receiving elements.

The flanges 91, 92 and 93, 94 exerting the acoustic filter effect of the ultrasonic flow meter 200 of Embodiment 7 are also configured from the magnetic material. The flanges 91, 92 and 93, 94 exerting the acoustic filter effect are provided one each between each ultrasonic transmitting-receiving means 80. By doing so, no special opening-closing means of the upper and lower sensor cases 20, 30 becomes necessary, and the upper and lower sensor cases 20, 30 may strongly clamp the tube by the adsorption power of the magnets of the flanges 91, 92 and 93, 94.

### Embodiment 8

An explanation will be given on Embodiment 8, as a modified embodiment of the embodiment shown in FIG. 2, although not drawing will be given. That is, Embodiment 8 is a combination of the technique of the ultrasonic wave attenuating means as a means for controlling the propagation of the ultrasonic wave of the present invention, and the technique of the flange exerting the acoustic filter effect. That is, in Embodiment 8, flange members exerting the acoustic filter effect including magnetic material are arranged by being fitted in the groove portions 50, 60 as the first ultrasonic wave attenuating means, that are provided between the pair of the ultrasonic transmitting-receiving means 40 in the lower sensor case 30 and the pair of the annular void portions 45 in the upper sensor case 20 in Embodiment 2 of FIG. 2. The flange members exerting the acoustic filter effect are reliably fixed or adhered to the groove portions 50, 60. With such configuration, it becomes possible to exert the acoustic filter effect of the flange member, and also to strongly clamp the upper and lower sensor cases 20, 30 to the tube by the magnetic absorption force of the flange member, without the need for a special opening-closing means for the upper and lower sensor cases 20, 30.

Of course, in Embodiment 8, it is possible to fit and arrange the flange members exerting the acoustic filter effect including magnetic material inside the groove portions 50, 60 of Embodiment 1 (FIG. 1). In this case, the acoustic wave attenuating means 51, 52 as is shown in FIG. 2 are not provided, so that the upper and lower sensor cases 20, 30 itself may be formed from a closed-pore foaming resin and the like. By doing so, it becomes possible to effectively attenuate the propagating wave of the unnecessary ultrasonic wave propagating through the upper and lower case sensors 20, 30, without providing a special ultrasonic wave attenuating means 51, 52. Needless to say, forming the upper and lower sensor cases 20, 30 itself from a closed-pore foaming resin and the like is not effective only in Embodiment 8, but is also applicable to other Embodiments 1 through 7.

Explanation had been given on the basis of each embodiment on the cases where the ultrasonic transmitting-receiving means are two or three. However, it is possible to provide a device with four or more means, by providing one ultrasonic transmitting-receiving means at the center, and a plurality of ultrasonic transmitting-receiving elements on both sides thereof. In the present invention, as is shown in FIG. 9, by realizing a situation where it is possible to detect only the received wave propagated through the medium inside the tube, the flow velocity may be detected, as is shown in equation (4) in Patent Document 5 (Japanese Patent Laid-Open No. 2000-180228), from the transmitting-receiving distance L and the propagating time difference between transmitting upstream and transmitting downstream. If the flow velocity of the medium may be detected as is explained above, it becomes possible to calculate the flow rate using the cross-sectional area inside the tube and the flow velocity coefficient (constant), and indicate the flow rate.

The ultrasonic flow rate measuring method using the ultrasonic flow rate measuring device of the present invention measures the flow rate of the medium flowing inside the tube, when bottling or canning the medium, by first stopping the transfer of the medium to make the flow velocity of the medium zero and thereafter performing zero point measurement by activating the ultrasonic flow rate measuring device, and thereafter measuring the flow velocity of the medium flowing inside the tube by restarting the transfer of the medium and activating the ultrasonic flow rate measuring device.

The present invention has been explained on the basis of the embodiments. However, the technical scope of the present invention is not limited to the specific structure of the embodiments, and includes the range capable of being changed easily by the person skilled in the art, on the basis of the constituent elements defined by the scope of the claims, provided that it exists within the scope of the inventive idea.

The effects of the present invention are as follows.

With the configuration explained above, the ultrasonic flow rate measuring device of the present invention is extremely easy to attach and detach with respect to a transfer tube during maintenance in a manufacturing process of various drinks, at a process of bottling or canning of the product, or during maintenance or cleaning of a medical equipment.

Further, with the configuration explained above, the present invention exerts an effect of making it possible to accurately measure the proper propagating wave propagating through the medium flowing inside the transfer tube, by effectively attenuating or interrupting the ultrasonic wave transmitting in the case.

Further, with the configuration as is explained above, the present invention exerts an effect of making it possible to accurately measure the proper propagating wave propagating through the medium flowing inside the transfer tube, by greatly detouring the unnecessary propagating wave of the ultrasonic wave transmitting in the case.

Further, in the ultrasonic flow rate measuring device of the present invention, an ultrasonic wave propagation control means is configured from an acoustic filter which absorbs unnecessary ultrasonic wave propagating the pair of the upper and lower sensor cases, and the acoustic filter is configured from a magnetic member, so that effective absorption of unnecessary ultrasonic wave and easiness of mounting are satisfied simultaneously.

In the ultrasonic flow rate measuring method of the present invention, a zero-point measurement is performed by once stopping the transfer of the medium, so that more accurate flow rate measurement is possible.

What is claimed is:

1. An ultrasonic flow rate measuring device, comprising:
a pair of upper and lower sensor cases configured to open and close freely, which clamps a tube body inside which a fluid to be measured flows from above and below; and
at least one sensor case embedded with a plurality of two or more semi-annular ultrasonic transmitting-receiving means, with a predetermined distance therebetween;
and which measures a flow rate of a medium flowing in the tube body by one of a plurality of the ultrasonic transmitting-receiving means transmitting an ultrasonic wave as a transmitting means, and another one of a plurality of the ultrasonic transmitting-receiving means receiving the ultrasonic wave as a receiving means,
wherein an ultrasonic wave propagation control means which controls a propagation of the ultrasonic wave is equipped between the ultrasonic transmitting-receiving means as the transmitting means and the receiving means.

2. The ultrasonic flow rate measuring device according to claim 1,
wherein a plurality of the ultrasonic transmitting-receiving means is configured from a pair of the ultrasonic transmitting-receiving means, and is configured so that in case one of the ultrasonic transmitting-receiving means transmits the ultrasonic wave as the transmitting means, the other ultrasonic transmitting-receiving means receives the ultrasonic wave as the receiving means, and in case the other ultrasonic transmitting-receiving means transmits the ultrasonic wave, the one ultrasonic transmitting-receiving means receives the ultrasonic wave as the receiving means.

3. The ultrasonic flow rate measuring device according to claim 1,
wherein a plurality of the ultrasonic transmitting-receiving means is configured from three ultrasonic transmitting-receiving means, and is configured so that the ultrasonic transmitting-receiving means positioned at a center transmits the ultrasonic wave as the transmitting means, and the ultrasonic transmitting-receiving means positioned at both sides receive the ultrasonic wave as the receiving means.

4. The ultrasonic flow rate measuring device according to claim 1,
wherein the ultrasonic wave propagation control means is a groove portion formed in a state of shielding an ultrasonic wave propagating path in the sensor case vertically to a tube axial direction of the tube body.

5. The ultrasonic flow rate measuring device according to claim 1,
wherein the ultrasonic wave propagation control means is configured from a plurality of ultrasonic wave attenuating means, and a first ultrasonic wave attenuating means is a first groove portion formed in a state of shielding an ultrasonic wave propagating path in the sensor case vertically to a tube axial direction of the tube body, and a second ultrasonic wave attenuating means is a second groove portion formed so as to surround the ultrasonic transmitting-receiving means.

6. The ultrasonic flow rate measuring device according to claim 4,
wherein the ultrasonic wave attenuating means comprising the groove portion is mounted with a foam body or a Japanese paper in the groove portion.

7. The ultrasonic flow rate measuring device according to claim 5,
wherein the ultrasonic wave attenuating means comprising the groove portion is mounted with a foam body or a Japanese paper in the groove portion.

8. The ultrasonic flow rate measuring device according to claim 1,
wherein the pair of the upper and lower sensor cases is freely opened and closed mutually and axially by a hinge.

9. The ultrasonic flow rate measuring device according to claim 1,
wherein the ultrasonic wave propagation control means is configured from a flange having an acoustic filter effect of absorbing the ultrasonic wave propagating through the pair of the upper and lower sensor cases.

10. The ultrasonic flow rate measuring device according to claim 9,
wherein the flange having the acoustic filter effect configuring the ultrasonic wave propagation control means is configured from a magnet material.

11. A method of measuring a flow rate of a medium flowing inside a tube body,
which uses an ultrasonic flow rate measuring device, comprising a pair of upper and lower sensor cases configured to open and close freely, which clamps a tube body inside which a fluid to be measured flows from above and below; and at least one sensor case is embedded with a plurality of two or more semi-annular ultrasonic transmitting-receiving means, with a predetermined distance therebetween; and which measures a flow rate of a medium flowing in the tube body by one of a plurality of the ultrasonic transmitting-receiving means transmitting an ultrasonic wave as a transmitting means, and another one of a plurality of the ultrasonic transmitting-receiving means receiving the ultrasonic wave as a receiving means, the ultrasonic flow rate measuring device further comprising an ultrasonic wave propagation control means which controls a propagation of the ultrasonic wave between the ultrasonic transmitting-receiving means as the transmitting means and the receiving means,
wherein the flow rate of the medium flowing inside the tube body is measured by, first stopping a transfer of the medium during bottling or canning of the medium to set a flow velocity of the medium to zero and perform zero-point measurement by activating the ultrasonic flow rate measuring device, and thereafter starting the transfer of the medium and activate the ultrasonic flow rate measuring device so as to measure the flow velocity of the medium flowing inside the tube body.

12. The ultrasonic flow rate measuring device according to claim 2,
wherein the ultrasonic wave propagation control means is a groove portion formed in a state of shielding an ultrasonic wave propagating path in the sensor case vertically to a tube axial direction of the tube body.

13. The ultrasonic flow rate measuring device according to claim 2,
wherein the ultrasonic wave propagation control means is configured from a plurality of ultrasonic wave attenuating means, and a first ultrasonic wave attenuating means is a first groove portion formed in a state of shielding an ultrasonic wave propagating path in the sensor case vertically to a tube axial direction of the tube body, and a second ultrasonic wave attenuating means is a second groove portion formed so as to surround the ultrasonic transmitting-receiving means.

14. The ultrasonic flow rate measuring device according to claim 12,
wherein the ultrasonic wave attenuating means comprising the groove portion is mounted with a foam body or a Japanese paper in the groove portion.

15. The ultrasonic flow rate measuring device according to claim 13,
wherein the ultrasonic wave attenuating means comprising the groove portion is mounted with a foam body or a Japanese paper in the groove portion.

16. The ultrasonic flow rate measuring device according to claim 2,
wherein the pair of the upper and lower sensor cases is freely opened and closed mutually and axially by a hinge.

17. The ultrasonic flow rate measuring device according to claim 2,
wherein the ultrasonic wave propagation control means is configured from a flange having an acoustic filter effect of absorbing the ultrasonic wave propagating through the pair of the upper and lower sensor cases.

18. The ultrasonic flow rate measuring device according to claim 17,
wherein the flange having the acoustic filter effect configuring the ultrasonic wave propagation control means is configured from a magnet material.

19. The ultrasonic flow rate measuring device according to claim 3,
wherein the ultrasonic wave propagation control means is a groove portion formed in a state of shielding an ultrasonic wave propagating path in the sensor case vertically to a tube axial direction of the tube body.

20. The ultrasonic flow rate measuring device according to claim 3,
wherein the ultrasonic wave propagation control means is configured from a plurality of ultrasonic wave attenuating means, and a first ultrasonic wave attenuating means is a first groove portion formed in a state of shielding an ultrasonic wave propagating path in the sensor case vertically to a tube axial direction of the tube body, and a second ultrasonic wave attenuating means is a second groove portion formed so as to surround the ultrasonic transmitting-receiving means.

21. The ultrasonic flow rate measuring device according to claim 19,
wherein the ultrasonic wave attenuating means comprising the groove portion is mounted with a foam body or a Japanese paper in the groove portion.

22. The ultrasonic flow rate measuring device according to claim 20,
wherein the ultrasonic wave attenuating means comprising the groove portion is mounted with a foam body or a Japanese paper in the groove portion.

23. The ultrasonic flow rate measuring device according to claim 3,
wherein the pair of the upper and lower sensor cases is freely opened and closed mutually and axially by a hinge.

24. The ultrasonic flow rate measuring device according to claim 3,
wherein the ultrasonic wave propagation control means is configured from a flange having an acoustic filter effect of absorbing the ultrasonic wave propagating through the pair of the upper and lower sensor cases.

25. The ultrasonic flow rate measuring device according to claim 24,
wherein the flange having the acoustic filter effect configuring the ultrasonic wave propagation control means is configured from a magnet material.
